(19) United States
(12) Patent Application Publication
(10) Pub. No.: US 2025/0363041 A1
(43) Pub. Date: Nov. 27, 2025

(54) SYSTEM AND METHOD FOR AUTOMATIC MODEL CHECKING OF GRAPHICAL PLC ALGORITHMS AND AUTOMATIC TEST CASE GENERATION

(71) Applicant: UNIVERSITY OF WEST BOHEMIA IN PILSEN, Pilsen (CZ)

(72) Inventors: Thomas Ausberger, Pilsen (CZ); Karel Kubicek, Pilsen (CZ); Pavla Medvecova, Pilsen (CZ)

(21) Appl. No.: 18/671,845

(22) Filed: May 22, 2024

(51) Int. Cl. G06F 11/36; G06F 8/35

(52) U.S. Cl. CPC G06F 11/3684; G06F 8/35; G06F 11/3692; G06F 2201/865

(57) ABSTRACT

A method of model checking a PLC algorithm inscribed in a graphical programming language and a method for automatic test case generation and model-based testing of the PLC implementing these PLC algorithms are provided. The model checking method includes converting the functional block diagram algorithm into a functionally-equivalent formalized functional block diagram algorithm. The method includes model checking the functionally-equivalent formalized functional block diagram algorithm. The verified PLC algorithm is a functional block diagram algorithm including discrete-time deterministic function blocks. The verified PLC algorithm can be then downloaded into a target PLC and periodically executed. The test case generation method includes predefined testable behaviors (unit tests) of each function block and combination of compatible unit tests to valid test cases according the assume-guarantee principle. The resulting test scenarios and test cases are used for model-based grey-box testing in MIL, SIL and HIL testing of the PLC implementing these PLC algorithms.

### TECHNICAL FIELD

The present disclosure relates generally to systems and methods for automatic model checking of algorithms for PLC and automatic test case generation. These methods can be combined or used separately.

### BACKGROUND OF CERTAIN ASPECTS OF THE DISCLOSURE

Safety-critical systems are systems which failure may lead to death, injuries, property damage, or environmental harm. Examples of safety-critical systems include nuclear power plants with complex and potentially dangerous processes. These processes involve heavy machinery, high temperature, high pressure, toxic substances, and radioactivity. Failure of these systems can be dangerous, and failure of a safety-critical system should be either avoided or its destructiveness should be reduced to an acceptable level. This can be maintained by studying and reducing hazardous risks by modifying the safety-critical system itself (e.g. by additional I&C systems stabilizing it) or by increasing its functional safety through additional safety functions.

Due to the increasing efficiency of computers, systematic digitization, and automation, the interest in functional safety has grown. This simultaneously affects the required level of overall safety and a set of systems considered safety critical. Traditionally, only systems capable of dealing damage to people or the environment had been considered safety-critical (e.g. heavy industry or power plants). Lately, however, systems interacting with people are also frequently considered safety-critical (e.g. semi-automated systems, collaborative robots, or autonomous cars), as the interaction with people makes them potentially dangerous to their operators and environment. Additional attention is also paid to systems that cannot be principally trusted due to their nature, like systems based on artificial intelligence.

Safety-related systems are systems that perform a safety function. The purpose of the safety function is to reduce the safety risk and protect the underlying system actively. These systems may consist of hardware, software, and human operators cooperating to perform some safety functions. A failure of a safety related system increases the risks of hazardous failures in the underlying system. Safety-related systems may include a safety-related Instrumentation and Control (I&C) nuclear power plant system. Any nuclear power plant contains numerous I&C systems with various purposes. Some of these systems act as safety-related systems and perform or appear to have some safety function. These systems have to be developed with caution and need to be proven reliable.

I&C systems may include software, hardware, electronic circuits and mechanical parts. Each part of an I&C system should be developed according to some explicitly defined development process. The development process of a safety-related or safety-critical system is commonly slower and more expensive. It is designed to minimize the number of defects introduced into the system. FIG. 1 shows a V-diagram of an example development process. This diagram displays individual phases of the development process. Initially, a design is constructed according to the requirements. After that, the system is implemented according to the design. Any implemented component has to be verified to ensure its correctness and reliability. Finally, the whole system is validated.

Any I&C system may contain defects that may cause faults or even failure. Defects can be introduced into the system by incorrect design or implementation. Once a defect is introduced into the system, it needs to be identified by verification and repaired. The development process then has to return to the stage in which the defect has been introduced to repair an identified defect. Suppose the error is introduced into the system in the earlier part of the development (left part of the V diagram illustrated in FIG. 1) and revealed only during later final testing (right part of the V diagram illustrated in FIG. 1). In that case, correction of the defect will be more expensive and time consuming. Therefore, defects in the system design may increase costs of the development process. Unfortunately, not all defects can be identified early in development. The number of identified defects depends on the verification methods and type of defects. Intuitively, the more essential or critical a system is, the more sophisticated verification methods should be utilized. Therefore, safety-critical and safety-related I&C systems should combine classic methods like testing or code review with sophisticated formal verification methods.

Formal verification methods are used to prove or disprove the correctness of algorithms with respect to a given formal specification or property. Formal methods are ideal to prove some fundamental properties of a system. They are not limited to specific scenarios (like testing) but rather consider the system as a whole. Therefore, in practice, classic verification methods are combined with formal verification methods to maintain the higher reliability of the system.

Model checking is a modern method of formal verification. It is a computer guided formal verification technique. It either proves a model satisfies a given requirement (specification or property) or returns a counterexample that violates it. This behavior predestines it to find bugs (defects) in a model design, as finding a bug is usually easier than proving its absence. Lately, this technique has been extended and improved. Hence, thanks to its potential, it is becoming widely adopted by researchers in many various fields.

One advantage of model checking is that it can be applied to designed models. It is often used to identify defects and misconceptions in a system design. These defects are commonly expensive to repair so that this method can lead to time and economic savings. Furthermore, thanks to its formal nature, model checking provides trustworthy conclusions. Either a model satisfies the given criteria or a counterexample is generated. In the second case, the generated counterexample can be interpreted and used to locate the defect or change the misguided specification.

Model checking has been transformed from experimental to industrial-ready verification methods in the last two decades. Modern model checkers are currently capable of checking complex real-life models. Thus, some great technical corporations have already adopted model checking and utilized in numerous applications. At this point, model checking is frequently used for hardware and software verification and simulation, examination, and verification of particular types of models (e.g. probabilistic models, biological models).

I&C systems (safety-related or not) are frequently controlled by a Programmable Logic Controller (PLC). The PLC is commonly programmed by one of the standardized programming languages defined in IEC 61131-3 standard: Ladder Diagram (LD), Function Block Diagram (FBD), Structured Text (ST), Instruction List (IL), and Sequential Function Chart (SFC). Intuitively, the methodology for model checking of these languages would simplify model checking of designed algorithms and lead to more reliable algorithms.

Safety-related I&C systems in nuclear power plants are frequently designed and programmed by Function Block Diagram (FBD) and Sequential Function Chart (SFC). These languages are ideal for model-based development, as they are transparent graphical languages that can be compiled (translated) into another language or code. Moreover, FBD algorithms of safety-related I&C systems in nuclear power plants are frequently composed of function blocks with Boolean or discrete-value signals only; these algorithms can be treated as discrete systems (specifically transition systems). Thus, these algorithms can be naturally verified by model checking. Also, these algorithms are suitable for model-based testing.

Safety-critical and safety-related systems have to be developed with caution. Their development process should be explicitly specified, transparent, and unambiguous. Numerous standards have been defined to clarify how to design and specify a development process for safety-related systems correctly and how to develop and utilize safety-related systems to protect some (possibly safety-critical) Equipment Under Control (EUC). These standards vary from generic to field specific. Commonly, they contain sets of necessary, recommended, disapproved, and forbidden attributes. Frequently, they share a common core and principles. Although these standards consider safety-critical systems only as EUC, the principles and the processes for developing safety-related systems specified in these standards may also be utilized to develop safety-critical systems.

Instructions for the specification of a development process for safety-related systems can be found in IEC 61508 standard “Functional Safety of Electrical/Electronic/Programmable Electronic Safety-related Systems.” This standard is divided into seven parts: the first three contain requirements, part four contains definitions, and the last three contain examples and guidelines. IEC 61508-1 “Part 1: General requirements” specifies a general development process (safety life cycle) and introduces hazard and risk analysis. IEC 61508-2 “Part 2: Requirements for electrical/electronic/programmable electronic safety-related systems” specifies electrical, electronic, and hardware development requirements. IEC 61508-3 “Part 3: Software requirements” defines criteria for software development. It should be noted that no software can be reasoned about separately without underlying hardware. Conclusions can be only made about the safety of a specific software running on a specific hardware.

IEC 61508-1 standard defines a safety life cycle (development process prototype) with 16 phases. These phases can be divided into analysis, realization, and operation phases. The primary aspect of the standard is the hazard and risk analysis. The standard states that there are always risks in EUC. These risks can be caused by EUC's physical, electric, electronic, hardware, and software components, but its environment and operators can also cause them. Thus, the main objective is not to eliminate all risks or reduce them to the lowest level possible but to reduce non-tolerable risks to a bearable level. Generally, the analysis initially defines a bearable level of risk. Thereafter, it considers possible risks and their consequences. If the total risk level is higher than the bearable level, the designer should take precautions to reduce the total risk to a bearable level. These precautions may include design changes or the design of additional safety functions.

The safety integrity level (SIL) represents the quality of safety-related functions. It is possible to require a safety-related function with specific SIL as a precaution to reduce the total risk to a bearable level. Criteria used for SIL classification may vary. Nevertheless, there are always four SIL categories. IEC 61508-3 standard defines an example SIL criterion for software. This criterion includes tables of highly recommended, recommended, and not recommended technologies and techniques for specific SIL classes. These techniques include techniques for software design (e.g. fault detection, stateless design, modeling), programming (e.g. coding standards, structured programming), and verification (e.g. formal methods, model checking, static analysis, testing). Techniques like artificial intelligence (AI) or dynamic reconfiguration are not recommended.

IEC 61508 standard is also frequently used as a generic template for the definition of other field-specific standards. ISO 26262 standard is an adaptation for automotive systems. IEC 62279 standard is an interpretation for railway control and protection systems. IEC 61511 standard sets out practices for industrial manufacturing processes (e.g. chemical, petrochemical, pharmaceutical). IEC 62061 standard provides requirements for machinery safety-related systems. IEC 61513 standard provides requirements and recommendations on power plant safety. IEC 61226 standard represents one of the numerous standards for nuclear power plants.

I&C systems are frequently controlled by Programmable Logic Controllers (PLC). Although various programming languages can program PLCs, they are commonly programmed by one of several standardized programming languages for PLC defined in IEC 61131-3 standard.

Ladder Diagram (LD) is a graphical language simulating a relay logic. A diagram includes two vertical lines (rails) and multiple horizontal lines (rungs) between them. A rung can contain wired mechanisms with various opening conditions. A diagram returns true if at least one rung connects the rails, i.e. when all mechanisms on the rung are open. Ladder diagrams simulate the wiring of electronic components. They cannot be used for the construction of complex algorithms.

Instruction List (IL) is a textual language similar to Assembler. An algorithm is programmed as an ordered list of low-level instructions. Execution of the algorithm is performed by sequentially calling (performing) instructions in the list. Instruction lists are ideal for compact time-critical code. However, IL is more challenging to master in comparison to the other languages. Moreover, it has only a few structuring possibilities. Therefore, it is sometimes considered obsolete.

Structured Text (ST) is a textual language similar to Pascal and C-like languages (e.g. C, Python, Java). An algorithm can be programmed by structured text to define variables, functions, conditions, or cycles. An algorithm is defined by high-level instructions (statements) separated by semicolons. This language is extensible and suitable for programming complex tasks. However, its syntax may be difficult to interpret.

Sequential Function Chart (SFC) is a graphical language simulating the decision-making process as a finite state automaton. SFC contains multiple states of a system and transitions between them. Transitions are represented by vertical lines connecting two or more states. Each transition contains a condition that has to be fulfilled to transfer the system into a particular following state. SFC may also contain parallel transitions, temporarily splitting the execution into multiple concurrent sequences. Each state of the system commonly represents some function that shall be executed. SFC can be efficiently designed and visually checked. However, it is suitable only for specific tasks, namely for tasks operating on explicit discrete states.

Function Block Diagram (FBD) is a graphical language simulating the computation of output values from given input values. Any FBD algorithm includes functions representing some mathematical functions (e.g. AND, OR, NOT) and function blocks with additional internal state (e.g. flip-flops, counters, real time delays). For simplification, both functions and function blocks will be noted as function blocks in this disclosure.

Each function block has its defined function, inputs, outputs, and inner states. A function block can be connected by lines to other function blocks, system inputs, or system outputs. Each line represents a variable characterizing a system input or a block's output. This variable can be utilized in system outputs or function blocks' inputs. Execution of the algorithm is performed by ordered execution of its function blocks. Each block initially reads values from the variables connected to its inputs, and then it executes its function, modifies its internal values, and stores the result in its output variables. One discrete execution of the algorithm executes all its functions. This execution must be performed to ensure each function block will have actualized values on its inputs before its own execution. The algorithm should also contain no un-handled feedback loop.

Function block diagrams are frequently used for the programming of control algorithms. Each block is characterized by its internal code, which performs the required function. The set of available function blocks may be easily extended. Thanks to its graphical design, an algorithm can be easily programmed by connecting various function blocks without additional knowledge about their internal implementation. However, as with other languages, poorly designed FBD algorithms may become disorganized and hard to interpret. An example of an FBD-like algorithm is illustrated in FIG. 2.

Methods of software and hardware verification are divided into static and dynamic analysis. Methods of dynamic analysis (e.g. testing) require a tested subject to be active and responding. In contrast, methods of static analysis work on designed models, programming code or statistics. Formal verification methods represent methods of static analysis operating on formal models and specifications. These mathematical methods can be used to prove or disprove that a model satisfies a given specification.

Although classic testing is the most common method of verification, it is insufficient for verification of safety-critical or safety-related I&C systems. Due to its nature, testing only checks a finite set of test cases which has to be defined beforehand. Because it is practically impossible to test any system completely, testing can discover only a limited set of defects. In contrast to testing, formal verification methods can consider whole behavior of a system at once. Therefore, they can verify the system completely and reveal plenty of defects which could not have been efficiently detected by testing. Conclusions of formal methods are considered highly trustworthy. Unfortunately, usage of formal methods suffers from few drawbacks. Formal methods can be used merely on formal models; any informal model has to be formalized (that is, create a formal version of it). It may be problematic to assume any conclusions from a formalized model for the original informal model. This problem is even more significant for an implemented solution which has to be modelled completely. Another drawback is connected with usage of analytic formal verification methods. These techniques require a mathematician to solve the formal verification problem analytically and provide an analytic proof. Therefore, it may be difficult, expensive and time-consuming to use these methods on large models and complex specifications.

Model checking is a formal verification method based on computer-aided analysis of state transition systems. This method is capable of verifying complex specifications on large-scale models. It is used to prove that a model M satisfies a required property ϕ defined in a specification, noted as M F. The method checks that the model M satisfies each state's property ϕ. Otherwise, it returns a sequence of states which violates the property § as a counterexample. Although this conclusion is mathematically computed, no analytic proof can be made. Such proof would be immensely complex and incomprehensible. Nevertheless, its mathematical nature and formalism make model-checking results nearly as trustworthy as analytic proof.

Model checking is performed by a specialized software called model checker. Model checkers vary in their modelling capabilities, implemented methods, and performance. The most notable model checkers are NuSMV, nuXmv, SPIN, UPPAAL or PRISM. Generally, a checked model of a Kripke structure represents M, and a formal specification ϕ is denoted in temporal-logic formulas (e.g. LTL, CTL). A model checker internally performs either explicit-state model checking (older and less effective) or symbolic model checking (modern and very effective). When a model checker processes a required property, it explicitly or virtually searches the state space. Then, it says that the property is satisfied or computes a sequence of states that violates it and returns it as a counterexample. A thorough description of model checking and its methods, extensions, and applications can be found in “Handbook of Model Checking”.

A process that implements model checking for verification of a model against its specification is displayed in FIG. 3. Required formal properties are specified either by a customer or an analyst. A formal model is designed independently by a designer of formal models. After that, a model checker verifies whether the model satisfies the required properties. If the model satisfies the specification, it can be passed to the following development phase. If the model violates the specification, the designer shall study the counterexample and either repair the model or revise the formal requirements.

As stated, model checking can only apply to formal models and specifications. In practice, this is problematic as the original model is commonly informal. Therefore, an equivalent formal model has to be created beforehand. A similar problem exists for formal specification. In practice, a customer only provides an informal specification that has to be formalized. However, there is a noticeable risk of incorrect formalization. Incorrectly formalized models or specifications lead to model checking of unwanted properties and misinterpreted results.

Accordingly, there is a need for a system and method that accurately and automatically checks algorithms.

### Formal Model—Kripke Structure

Generally, model checking can be used solely on transition systems. Transition system includes a set of states and a set of allowed transitions between these states. In time, a system evolves from one state to another according to allowed atomic transitions. Contrary to reactive systems, transition systems do not react with their environment. These reactions have to be part of the particular system. Although transition systems do not necessarily have a finite number of states and transitions, model checking is limited to models with finite states and transitions. Transition systems are typically depicted as finite-oriented graphs where vertices represent states s₀, . . . , sₙ and edges represent allowed transitions between these states. Allowed transitions are inscribed as (sᵢ, s′ⱼ) where sᵢ is a source state, and s′ⱼ represents a prime copy of the next state. In this context, a prime copy s′ represents state s in the next time step.

Path in a transition system represents a sequence of occurred states. There is no additional limitation on in which state it starts and in which it ends. Paths can be either finite or infinite. However, only paths which do not traverse into leaf states can be infinite. In order to allow infinite paths considering these states, a transition (sᵢ, s′ᵢ) has to be added for each leaf state sᵢ. These transitions express that a system stays in the same state. Therefore, the system does not stop evolving in time but stops evolving in states.

Run is an infinite path that starts in the transition system's initial state. Run is a term from finite-states automata. Nevertheless, it can be used for transition systems with defined initial states.

Computation is a fair run. Like run, computation is a term from finite states automata. The term fairness is not described here, as this document is, for better clarity, limited to Kripke fairness-free structures. Therefore, each run in a Kripke structure is considered a computation.

Kripke structure represents transition systems with initial states, atomic prepositions, and a labelling function. Kripke structures are especially favored for model checking. Historically, only a model represented by a Kripke structure could be verified by model checking. However, the class of models suitable for model checking has been expanded in time.

Definition 1—A Kripke structure (or state transition system) M is a quintuple M= [symbol] AP, S, S₀, R, L [symbol] where AP is a finite set of atomic propositions, S is a finite set of states, S₀⊆S is a set of initial states, R⊆S×S is a total transition relation and L:S→2^{AP} is a labelling function.

Kripke structures are state-labelled transition systems. Each Kripke structure includes atomic prepositions AP, which represent the atomic Boolean knowledge or variables of a system (e.g. a lock is locked, a button is pressed, a device is in ready state, a processor is at a specific line of code). Furthermore, the Kripke structure contains a labelling function L. This function uniquely maps each state to specific values of AP; therefore, there can be maximally 2^{AP} states. The labelling function associates every state with the set of atomic propositions that are true in it.

Definition 2—A path π in a Kripke structure is an infinite sequence π=s₀ s₁ . . . of states such s₀∈S and for all i≥0, (sᵢ, sᵢ₊₁)∈R.

Definition 3—A run is such path π=s₀, s₁, . . . where s₀∈S₀.

### Example 1

A Kripke structure M= [symbol] AP, S, S₀, R, L [symbol] .

$$AP = \{ p , q , r \}$$

$$S = \{ {s}_{0} , {s}_{1} , {s}_{2} , {s}_{3} , {s}_{4} \}$$

$${S}_{0} = \{ {s}_{0} \}$$

$$R = \{ ( {s}_{0} , {s}_{0}^{′} ) , ( {s}_{0} , {s}_{1}^{′} ) , ( {s}_{0} , {s}_{2}^{′} ) , ( {s}_{1} , {s}_{3}^{′} ) , ( {s}_{2} , {s}_{3}^{′} ) , ( {s}_{2} , {s}_{4}^{′} ) , ( {s}_{3} , {s}_{3}^{′} ) , ( {s}_{4} , {s}_{4}^{′} ) \}$$

$$L = \{ ( {s}_{0} , \{ p , q \} ) , ( {s}_{1} , \{ q \} ) , ( {s}_{2} , ∅ ) , ( {s}_{3} , \{ q , r \} ) , ( {s}_{4} , \{ r \} ) \}$$

This example is displayed in FIG. 4. The atomic prepositions p, q, r represent all system variables. The labelling function L uniquely maps each state sᵢ to AP values. The only initial state so is marked by a double circle.

### Formal Specification

Another fundamental part of model checking (and formal verification in general) is formal specification. A specification includes multiple formal requirements. Each requirement specifies a required property of a model; for a model represented by a Kripke structure M, the required property ϕ represents some relationship between the model's atomic propositions p∈AP. If a model M satisfies a given requirement ϕ, it is denoted as M [symbol] ϕ. If the model violates the requirement, it is denoted as M [symbol] ϕ or equally M [symbol] ¬ϕ.

Definition 4—For a model M and a required property ϕ, model checking problem is to decide whether the model M satisfies (implements) the property ϕ.

Temporal logic is a set of modal logics designed to reason about time. Any temporal logic contains some temporal operators used to quantify time. These logics are ideal for specifying the model's behavior in time. Hence, they have become the most used formalism for specifying required properties in model checking. The most known temporal logics are LTL (Linear Temporal Logic), CTL (Computation Tree Logic), and CTL* (a superset of CTL and LTL). Temporal logics frequently implement quantifiers known from predicate calculus. Universal quantifiers V are often denoted as A (i.e. for all). Existential quantifiers 3 are often denoted as E (i.e. exists). Although these quantifiers originate from predicate calculus, their usage may be modified or limited.

A specification created at the beginning of a development process is generally inscribed in human-readable text. This specification is unsuitable for model checking and has to be transcribed into a formal specification. Unfortunately, the original specification is frequently informal, vague, ambiguous, and unclear. This can lead to misinterpretation during the composition of the formalized specification. However, this would render model checking (or another formal verification method) useless. The checked properties would differ from the requested initial ones. Moreover, the model checking results of misinterpreted properties could falsely encourage a designer to create a model violating the original human-readable requirements. Conclusively, it is of utmost importance to create the formal specification properly.

A model's specification may include multiple complex required properties. However, two types of formal properties are frequently used in practice. A safety property states that a “bad” thing never occurs in a system. A liveness property states that a “good” thing eventually occurs in a system.

Safety property is a specification never to be violated. When an error (violation) occurs on a path π, it cannot be undone, and all possible extensions are also unsafe.

Invariant property is an essential safety property that can be inscribed by propositional logic. An invariant property is time-invariant; it does not change in time. Therefore, an invariant has to hold in all states.

Liveness property is a specification to hold eventually. When an error (violation) occurs on a path π, an extension has to exist that assures the property will eventually hold.

### Linear Temporal Logic

LTL (Linear Temporal Logic) is a linear-time temporal logic without path quantifiers. An LTL formula is a propositional logic with additional temporal operators. Missing path quantifiers cause the linearity of time. An LTL formula has to satisfied at all paths of a model. This concept can be easily understood; the model has to satisfy the requirement in any circumstances. Because of its linear-time nature, it is easy to understand. It is also the most popular temporal logic for specifying required properties. LTL formulas contain no quantifier. However, any LTL formula can implicitly assume an enclosing A quantifier.

Definition 5—LTL is generated by following context-free grammar:

$$ϕ \text{::} = p \vert ¬ ϕ \vert ϕ ∨ ϕ \vert ϕ ∧ ϕ \vert X ϕ \vert F ϕ \vert G ϕ \vert ϕ U ϕ where p ∈ AP$$

Other standard propositional logic operators (implication, equivalence) can be derived from the present ones. Essential temporal operators X, F, G, U are defined as follows: ϕ and ψ represent generic LTL sub-formulas.
Xϕ—Next: Next state must satisfy ϕ.
Fϕ—Future: In future (eventually), a state that satisfies ϕ must occur. It can also be satisfied immediately.
Gϕ—Globally: ϕ must be satisfied always.
ϕUψ—Until: ϕ must hold until ψ occurs, and ψ has to eventually occur.

Additional temporal operators W, R can be derived from the essential ones. Inverse temporal operators are omitted.
ϕWψ—Weak until: ϕ must hold until ψ occurs or infinitely.
ϕRψ—Release: ϕ release ψ; ψ must hold until ϕ occurs (they must hold simultaneously) or infinitely.

A complete formula always represents a model in its initial state. Nevertheless, the represented time can be further modified by using temporal operators. Every time a temporal operator is used, the represented time context is inherited by the operator's sub-formulas.

### Example 2

Consider the following LTL formulas. These formulas will be explained using k as a zero-based discrete time step.

$$q \qquad ( 1 )$$

$$X ( q ) \qquad ( 2 )$$

$$F ( q ) \qquad ( 3 )$$

$$X ( F ( q ) ) \qquad ( 4 )$$

$$G ( q ) \qquad ( 5 )$$

$$F ( G ( q ) ) \qquad ( 6 )$$

$$F ( p = ⇒ q ) \qquad ( 7 )$$

$$F ( p = ⇒ X ( q ) ) \qquad ( 8 )$$

where: formula 1 states q holds in the initial state (k=0); formula 2 states q holds in the next state after the initial state (k=1); formula 3 states q has to eventually hold (k≥0). It can hold in any future state from the initial state, including the initial state itself; formula 4 states that after one step q has to eventually hold (k≥1); formula 5 states q always holds (k≥0); formula 6 states there has to exist a moment (k_{F}≥0) from which q always hold (k≥k_{F}); formula 7 states there has to exist a moment (k_{F}≥0) in which p (k_{F}) implies q (k_{F}); and formula 8 states there has to exist a moment (k_{F}≥0) in which p (k_{F}) implies q in the following state (k_{F}+1).

These examples demonstrate the inheritance of time context in sub-formulas.

### Computation Tree Logic

CTL (Computation Tree Logic) is a branching-time temporal logic with path quantifiers restricted to temporal operators. CTL utilizes path quantifiers to quantify various possible paths at once. A sub-formula is required for all possible paths (A) or at least one path (E). A CTL formula is constructed in the same manner as an LTL formula. However, each temporal operator in a CTL formula has to be quantified. Moreover, a quantifier can be used only with a temporal operator.

Definition 6—CTL is generated by following context-free grammar:

$$ϕ \text{::} = p \vert ¬ ϕ \vert ϕ ∨ ϕ \vert ϕ ∧ ϕ \vert AX ϕ \vert EX ϕ \vert AF ϕ \vert EF ϕ \vert AG ϕ \vert EG ϕ \vert A ( ϕ U ϕ ) \vert E ( ϕ U ϕ )$$

where p∈AP.

Similarly to LTL, additional temporal operators (AW, EW, AR, ER) can be derived from the essential ones.

### Example 3

Consider the following CTL formulas. These formulas will be explained using k as a zero-based discrete time step.

$$q \qquad ( 9 )$$

$$AX ( q ) \qquad ( 10 )$$

$$EX ( q ) \qquad ( 11 )$$

$$AF ( q ) \qquad ( 12 )$$

$$EF ( q ) \qquad ( 13 )$$

$$AF ( AG ( q ) ) \qquad ( 14 )$$

$$AF ( EG ( q ) ) \qquad ( 15 )$$

$$EF ( EG ( q ) ) \qquad ( 16 )$$

where: formula 9 states q holds in the initial state (k=0); formula 10 states q holds in all possible next states (k=1) after the initial state; formula 11 states q holds in at least one possible next state (k=1) after the initial state; formula 12 states q eventually hold (k≥0) in each possible future; formula 13 states q eventually hold (k≥0) in at least one possible future; formula 14 states that in each possible future, there has to exist a moment (k_{F}≥0) from which q always hold (k≥k_{F}) in each subsequent future; formula 15 states that in each possible future, there has to exist a moment (k_{F}≥0) from which q always hold (k≥k_{F}) in at least one subsequent future; and formula 16 states that in at least one possible future, there has to exist a moment (k_{F}≥0) from which q always hold (k≥k_{F}) in at least one subsequent future.

These examples demonstrate the difference between A and E path quantifiers.

### BRIEF SUMMARY OF SOME ASPECTS OF THE DISCLOSURE

One aspect of the present disclosure relates to a method of model checking a PLC algorithm inscribed in a graphical programming language. The method includes converting the functional block diagram algorithm into a functionally-equivalent formalized functional block diagram algorithm. The method further includes model checking the functionally-equivalent formalized functional block diagram algorithm. The verified PLC algorithm is a functional block diagram algorithm consisting of discrete-time deterministic function blocks with inputs, outputs and inner states (modelled states and auxiliary states). The verified PLC algorithm can be then downloaded into a target PLC and periodically executed. This process can be also utilized for algorithms in other graphical PLC programming languages like ladder diagram and sequential function chart.

Another aspect of the present disclosure relates to a method of generation of test cases for a PLC algorithm inscribed in a graphical programming language and model-based grey-box testing of the PLC implementing these PLC algorithms. The method is based on predefined testable behaviors (unit tests) of each function block and combination of compatible unit tests to valid test cases according the assume-guarantee principle. The test case generation method includes parsing the functional block diagram algorithm into separable components, parsing separable components into tree-graph subcomponents, exhaustive generation of subcomponents' pseudo test cases from function blocks' unit tests, SMT based generation of test cases from subcomponents' pseudo test cases (model unit test) and joining the test cases of separable component into test scenarios. The resulting test scenarios and test cases can be used for model-based grey-box testing in MIL, SIL and HIL testing of the PLC implementing these PLC algorithms. This process can be also utilized for algorithms in other graphical PLC programming languages like ladder diagram and sequential function chart.

There are other novel aspects and features of this disclosure. They will become apparent as this specification proceeds. Accordingly, this brief summary is provided to introduce a selection of concepts in a simplified form that are further described below in the detailed description. The summary and the background are not intended to identify key concepts or essential aspects of the disclosed subject matter, nor should they be used to constrict or limit the scope of the claims. For example, the scope of the claims should not be limited based on whether the recited subject matter includes any or all aspects noted in the summary and/or addresses any of the issues noted in the background.

### BRIEF DESCRIPTION OF THE DRAWINGS

A further understanding of the nature and advantages of the embodiments may be realized by reference to the following drawings. In the appended figures, similar components or features may have the same reference label.

FIG. 1 illustrates an example V-diagram of an example development process in accordance with aspects of the present disclosure.

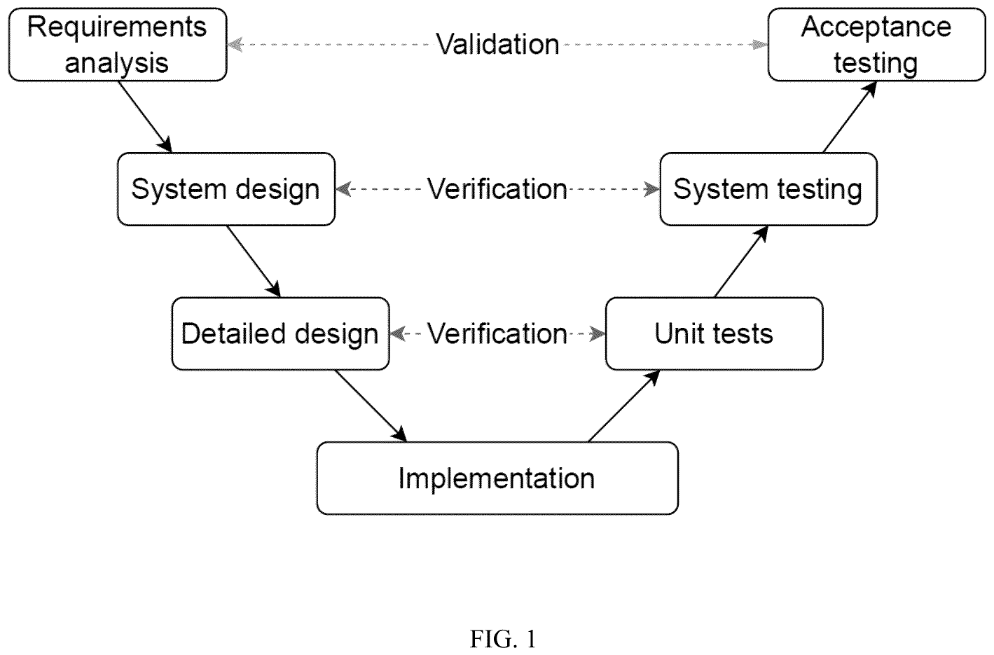

FIG. 2 illustrates an example of a general FBD-like algorithm design in accordance with aspects of the present disclosure.

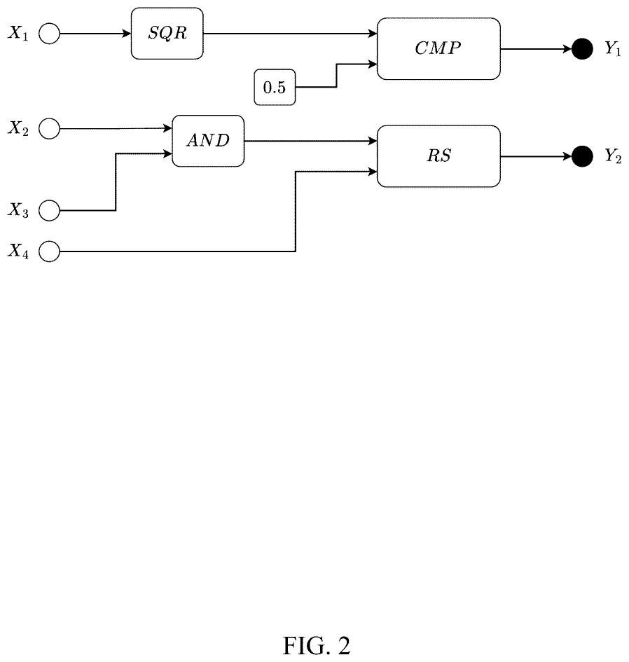

FIG. 3 illustrates an example of a model checking process in accordance with aspects of the present disclosure.

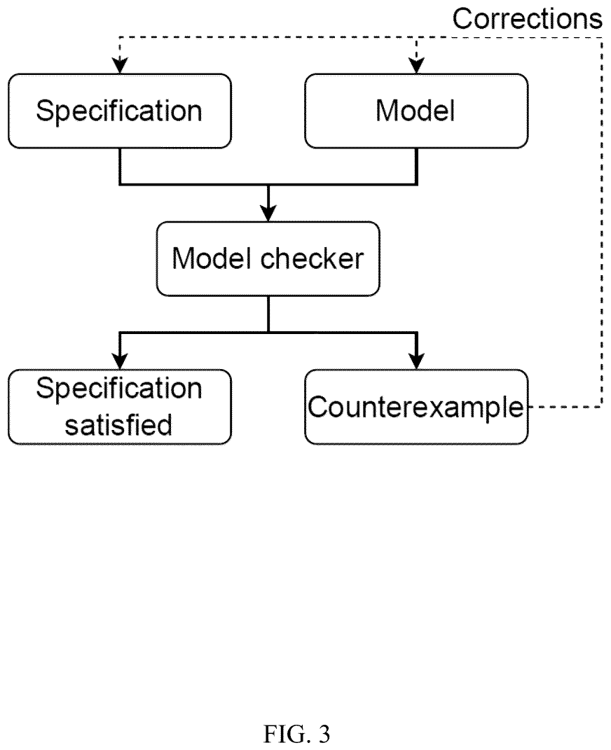

FIG. 4 illustrates an example Kripke structure M in accordance with aspects of the present disclosure.

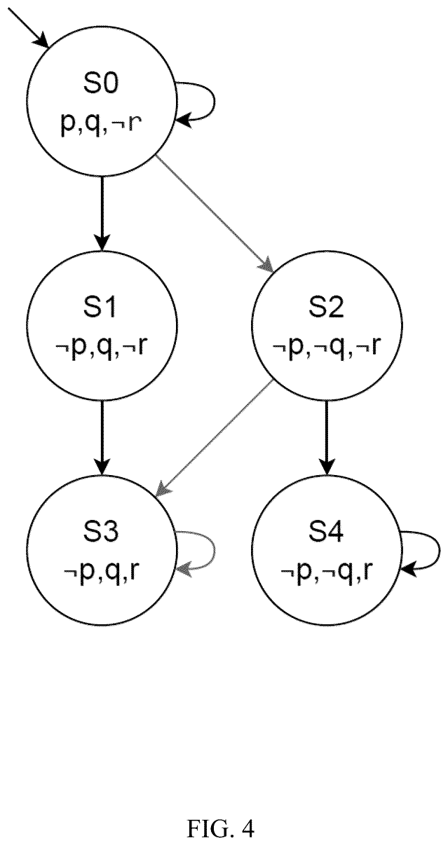

FIG. 5 illustrates an example of a flow diagram of a model formalization process in accordance with aspects of the present disclosure.

FIG. 6 illustrates an example of applied model checking methods.

FIG. 7 illustrates an example of an automated model checking methods within the V-diagram shown in FIG. 1 in accordance with aspects of the present disclosure.

FIG. 8 illustrates an example of automated test case generation and model-based testing within the V-diagram shown in FIG. 1 in accordance with aspects of the present disclosure.

FIG. 9 illustrates an example of a system in accordance with aspects of the present disclosure.

FIG. 10 illustrates an example of a system including a device in accordance with aspects of the present disclosure.

FIG. 11 illustrates a flow chart illustrating a method of model checking an algorithm in accordance with aspects of the present disclosure.

FIG. 12 illustrates a flow chart illustrating a method of test case generation and model-based testing in accordance with aspects of the present disclosure.

FIG. 13 illustrates an example of a flow diagram of generating test cases by a model test case generation and model-based testing method in accordance with aspects of the present disclosure.

FIG. 14 illustrates an example of an FBD algorithm M with a tree subcomponent in accordance with aspects of the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods disclosed herein relate to, among other things, automatically converting a PLC algorithm into a functionally equivalent formal PLC algorithm in a process called functional-equivalent formalization and verify it by model checking by a third-party model checker. Because the formal PLC algorithm is proven to be functionally equivalent to the original PLC algorithm, the obtained model checking result for the formal PLC algorithm can be immediately assumed in the original PLC algorithm. Therefore, a model checking against some formal requirements can automatically verify an original PLC algorithm.

The systems and methods described herein may be extended to parse and convert PLC algorithms of various PLC systems and from multiple computer-readable notations (i.e. various designing tools). Additionally, the systems and methods may be integrated into the development tools provided by a producer of a particular PLC system. This way, a developer of PLC algorithms can verify the PLC algorithms he designed by model checking immediately after he designs them.

The systems and methods described herein mainly focus on model checking of PLC algorithms inscribed in graphical languages (i.e. FBD, SFC, LD). The methodology was initially developed for FBD algorithms. However, since FBD is the most complex language and SFC and LD can be easily transformed into FBD, the methodology can also be applied to these algorithms and their combinations.

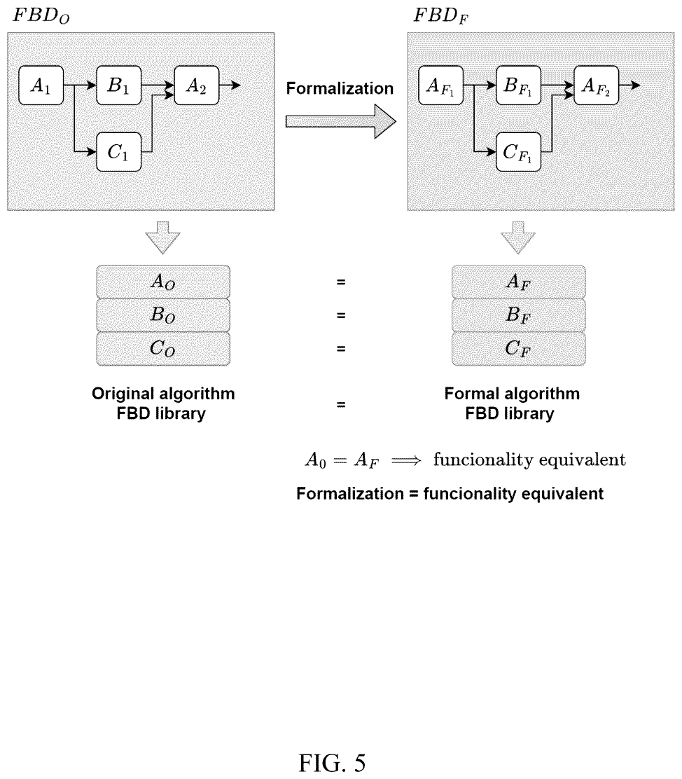

The idea of transforming an original FBD algorithm into a formal one is shown in FIG. 5. A formal FBD algorithm is subsequently created from the original FBD algorithm by replacing the original function blocks with their functionally equivalent formal counterparts. Each utilized original function block from a library of original function blocks has to have its functionally equivalent formal function block in a library of formal function blocks. These function blocks have to be defined only once by the producer of the particular PLC system. Note that the functional equivalence of two function blocks is easier to maintain and verify than their equality. Additional limitations of function block that can be verified may arise from the limitations of the utilized model checker (e.g. a requirement on finite-state models only).

The formal requirements (LTL, CTL) are manually created from the human-readable original specification of the given system before the model checking starts. These formal requirements must be provided with the original PLC algorithm in the presented SW. Once the systems and methods described herein create the functionally equivalent formal PLC algorithm, it internally executes the selected model checker to perform model checking of the formal PLC algorithm against its formal requirements. After that, the SW processes and returns the results to the developer. Since the formal PLC algorithm is functionally equivalent to the original PLC algorithm, the model checking results (against correctly specified formal requirements) for the formal PLC algorithm can also be assumed for the original PLC algorithm. Therefore, an original PLC algorithm can be verified using the formalized PLC algorithm's functionally equivalent conversion and model checking.

Each PLC algorithm has to be designed by a PLC algorithm developer (programmer) in a development environment, and a producer of a particular PLC system provides development tools. Once the developer designs all PLC algorithms according to their specification, these algorithms should be ideally verified by model checking to detect hidden faults and misinterpretations of the specification.

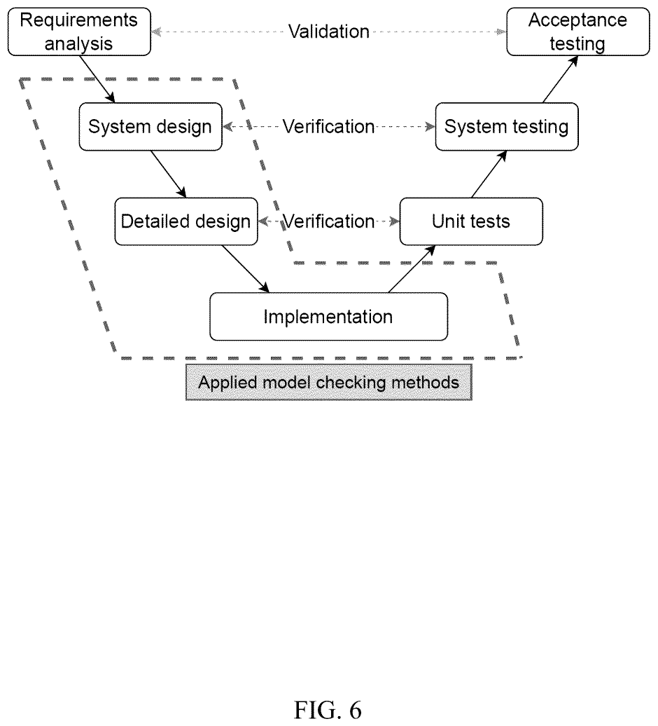

Currently, using model checking of PLC algorithms in practice involves several additional steps and people. There is no unified general tool for model checking the PLC algorithm yet. Thus, any new FBD algorithm has to create its formal model manually. This work requires a highly skilled expert in formal modelling and PLC systems. The expert has to analyze the designed PLC algorithms manually and the used PLC system and carefully create a correct formal model. This model may and may not be equivalent to the verified PLC algorithms. Thus, the obtained model-checking results may or may not be expected in the verified PLC algorithms. Note that in some cases, the expert may even do this simplification intentionally, but then he must correctly interpret the obtained model checking results. At the same time, an expert on formal safety requirements has to analyze the human-readable specification and manually create a formal specification consisting of particular formal requirements (e.g. LTL or CTL requirements ϕ). After that, a selected model checker automatically performs the model checking. The PLC algorithms must be repaired if the formal model does not satisfy its formal requirements. Since a standard developer of PLC algorithms is not expected to be an expert on formal modelling, its company has to hire an expert or order contract research for each verified set of PLC algorithms, which is time-consuming and financially demanding. The idea of model checking of formal models manually constructed by a formal modelling expert is shown in FIG. 6 with the parts of the development process where the verification by model checking can be applied.

The systems and methods described herein automate model checking of PLC algorithms. The systems and methods described herein can be either utilized as a standalone application or implemented directly into the development tools provided by a producer of a particular PLC system. Either way, a developer can verify its PLC algorithms by model checking immediately after he designs them. Hence, only PLC algorithms verified by model checking should be compiled and uploaded into the target PLC device. However, suppose a PLC algorithm does not satisfy its formal requirements. In that case, the developer can immediately analyze the obtained counterexample and use it to repair the PLC algorithm violating the formal requirement. Thereafter, verifying the repaired PLC algorithm by model checking should be repeated until it completely satisfies its formal specification. It is also necessary to specify formal requirements in temporal logic (LTL, CTL) before the model checking is started. Nonetheless, it is possible to train a person in basic temporal logic and let him write the simplest and recurring formal requirements according to some explicit guidebook. This may reduce the need for an expert on formal safety requirements.

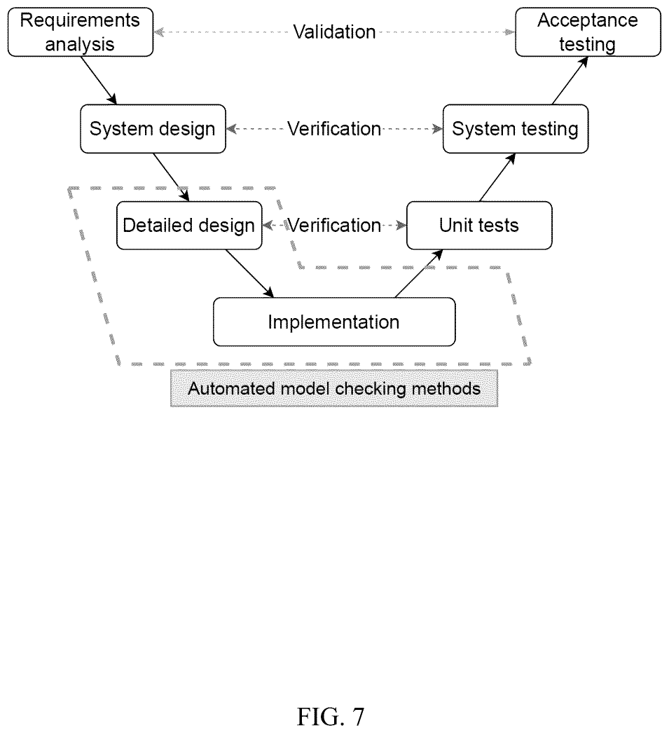

The advantage of this modified process is that a developer can verify any PLC algorithm by automated model checking with a single push of a button in the development tools of the particular PLC system. There is no need to use the expertise of experts and contract researchers, which can be expensive. Hence, model checking of the PLC algorithm incorporated in this way can lead to time and money savings during the development of PLCs and to much higher safety and reliability of developed systems. This is shown in FIG. 7 on the parts of the development process where the verification by automated model checking with the systems and methods described herein can be applied.

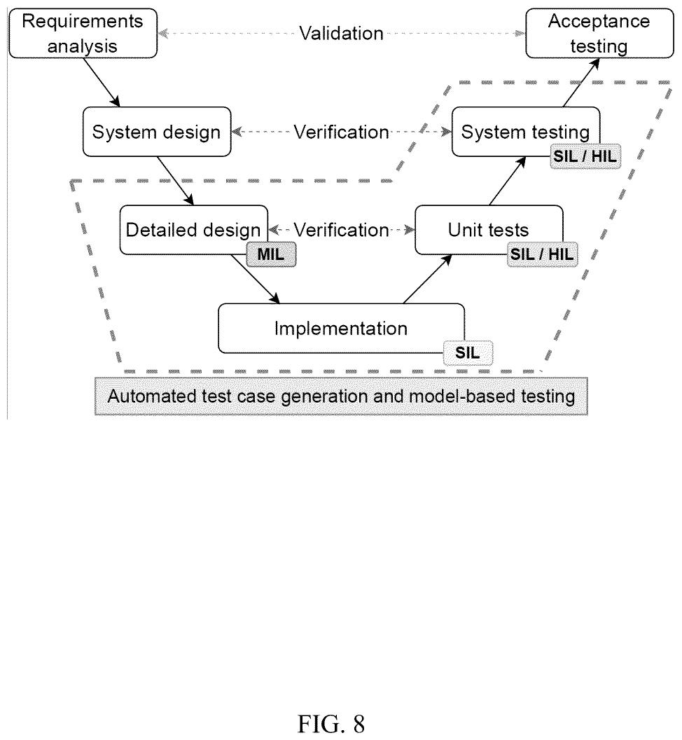

Specifically, incorporating tools for model checking into a given SW development environment simplifies the use of model checking as shown in FIG. 7. This way, a PLC algorithm can be designed and verified in the same development environment with minimum effort. Additionally, the approach can be applied to any graphical programming language: FBD, SFC and LD and their combinations. Additionally, incorporating the model checking method into the V-diagram can lead to substantial cost savings caused by early detection of faults and misinterpretations in designed PLC algorithms. Additionally, incorporating the model checking method into the V-diagram leads to significantly safer, more reliable and higher quality systems and products. Moreover, the integration of the systems and methods described herein into development tools of PLC systems can lead to a broader use of model checking in industry, even in fields where it has not yet been employed due to required time and finance. Furthermore, the systems and methods described herein can be combined with methods for automatic test generation and automatic model-based testing. Once a PLC algorithm is verified by model checking, a set of test cases can be generated for MIL (Model In the Loop), SIL (Software In the Loop) and HIL (Hardware In the Loop) grey-box testing to verify that the checked PLC algorithm is correctly implemented in the target PLC. Utilizing the method for test case generation and model-based testing for verification of the PLC implementing this algorithm is illustrated in FIG. 8.

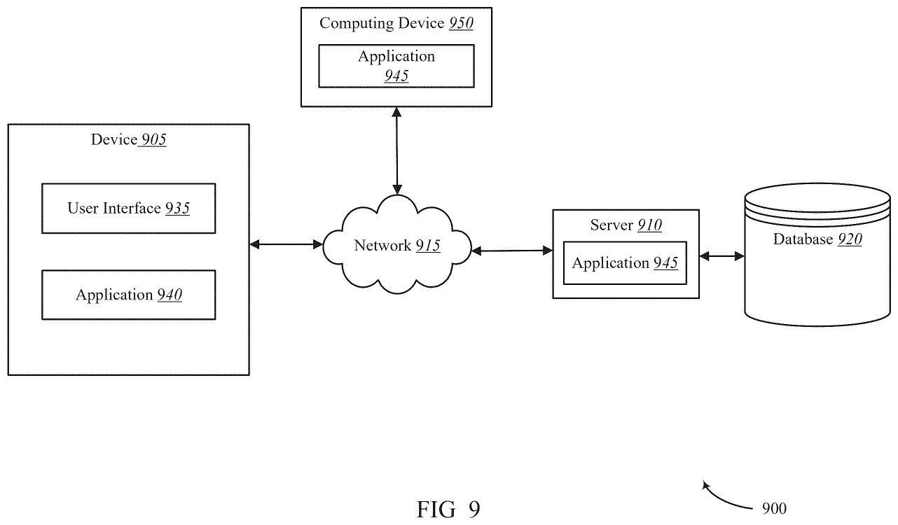

FIG. 9 illustrates a block diagram illustrating one example of a system 900 in which the present systems and methods may be implemented. In some examples, the systems and methods described herein may be performed on a device (e.g., device 905). As depicted, the system 900 may include a device 905, a server 910, a network 915, a database 920, and a computing device 910, and that allows the device 905, the server 910, and the database 920 to communicate with one another.

Examples of the device 905 may include any combination of, for example, mobile devices, smart phones, personal computing devices, computers, laptops, desktops, servers, media content set top boxes, or any combination thereof. However, the device 905 may be any device that enables the systems and methods described herein to operate as described herein.

Examples of computing device 910 may include at least one of one or more client machines, one or more mobile computing devices, one or more laptops, one or more desktops, one or more servers, one or more media set top boxes, or any combination thereof. However, the computing device 910 may be any computing device that enables the systems and methods described herein to operate as described herein.

Examples of server 910 may include, for example, a data server, a cloud server, proxy server, mail server, web server, application server, database server, communications server, file server, home server, mobile server, name server, or any combination thereof. However, the server 910 may be any computing device that enables the systems and methods described herein to operate as described herein.

Although database 920 is depicted as connecting to device 905 via network 915, in some examples, device 905 may connect directly to database 920. In some examples, device 905 may connect or attach to at least one of database 920 or server 910 via a wired or wireless connection, or both. In some examples, device 905 may attach to any combination of a port, socket, and slot of a separate computing device or server 910.

In some configurations, the device 905 may include a user interface 935 and an application 940. Although the components of the device 905 are depicted as being internal to the device 905, it is understood that one or more of the components may be external to the device 905 and connect to the device 905 through wired or wireless connections, or both. Examples of the application 940 may include a web browser, a software application, a desktop application, a mobile application, etc. In some examples, the application 940 may be installed on a computing device in order to allow a user to interface with a function of the device 905, the server 910, and the computing device 910.

Although the device 905 is illustrated with an exemplary single application 940, in some examples the application 940 may represent two or more different applications installed on, running on, or associated with the device 905. In some examples, the application 940 may include one or more software widgets. In some cases, the application 940 may include source code to operate one or more of the systems, system components, and/or methods described herein.

In some examples, the device 905 may communicate with the server 910 via the network 915. Examples of the network 915 may include any combination of cloud networks, local area networks (LAN), wide area networks (WAN), virtual private networks (VPN), wireless networks (using 805.11, for example), cellular networks (using 3G, LTE, or 5G, for example), etc. In some configurations, the network 915 may include the Internet. For example, the device 905 may include the application 940 that allows the device 905 to interface with a separate device via an application 945 being located on another device such as a separate computing device, server 910, database 920, or any combination thereof.

In some examples, at least one of the device 905, the database 920, and the server 910 may include an application 945 where at least a portion of the functions of the application 940 are performed separately or concurrently on the device 905, the database 920, and/or the server 910. In some examples, a user may access the functions of the device 905 (directly or through the device 905 via the application 945) from the database 920 or the server 910. In some examples, the database 920 includes a mobile application that interfaces with one or more functions of the device 905 and/or the server 910.

In some examples, the server 910 may be coupled to the database 920. The database 920 may be internal or external to the server 910. In one example, the device 905 may be coupled to the database 920. In some examples, the database 920 may be internally or externally connected directly to the device 905. Additionally or alternatively, the database 920 may be internally or externally connected directly to the computing device 910 or one or more network devices such as a gateway, switch, router, intrusion detection system, etc. The database 920 may include the application 945. In some examples, device 905 may access or operate aspects of the application 945 from the database 920 over the network 915 via the server 910. The database 920 may include script code, hypertext markup language code, procedural computer programming code, compiled computer program code, object code, uncompiled computer program code, object-oriented program code, class-based programming code, cascading style sheets code, or any combination thereof.

In one example, the device 905 may be coupled to the database 920. In some examples, the database 920 may be internally or externally connected directly to the device 905.

Additionally or alternatively, the database 920 may be internally or externally connected directly to one or more network devices such as a gateway, switch, router, intrusion detection system, etc.

The application 945 may enable a variety of features and functionality related to the systems and methods described herein. In some examples, the application 945 may be configured to perform the systems and methods described herein in conjunction with the user interface 935 and the application 940. The user interface 935 may enable a user to interact with, control, or program one or more functions of the application 945.

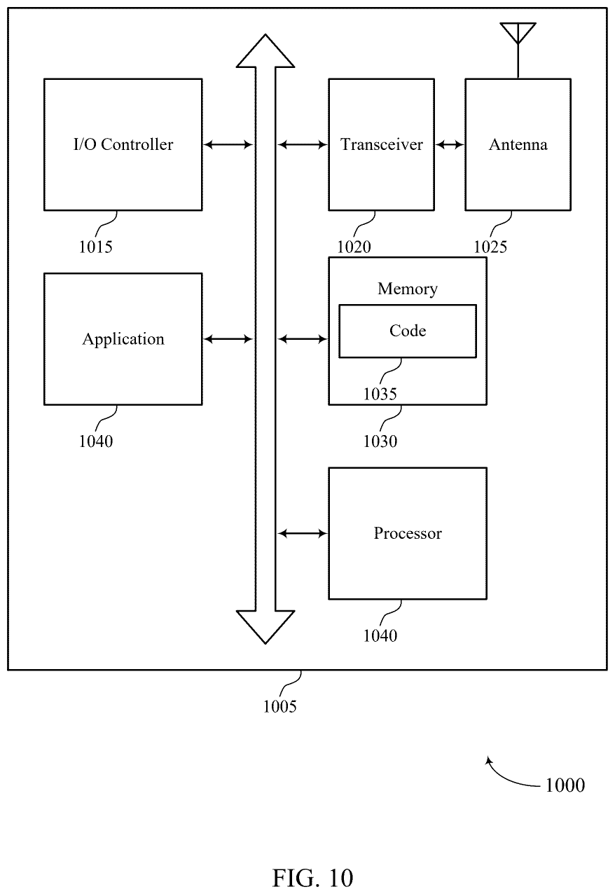

FIG. 10 shows a diagram of a system 1000 including the device 1005 that performs the systems and methods described herein. The device 1005 may be an example of or include the components of device 905 or devices as described herein. The device 1005 may include components for bi-directional voice and data communications including components for transmitting and receiving communications, including the application 940, an I/O controller 1015, a transceiver 1020, an antenna 1025, memory 1030, and a processor 1040. These components may be in electronic communication via one or more buses.

The application 1040 may provide any combination of the operations and functions described herein related to the systems and the methods described herein.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described herein. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include RAM and ROM. The memory 1030 may store computer-readable, computer-executable code 1035 including instructions that, when executed, cause the processor to perform various functions described herein. In some cases, the memory 1030 may contain, among other things, a BIOS which may control basic hardware or software operation such as the interaction with peripheral components or devices.

The processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting menu related functions and other functions associated with the systems and methods disclosed herein).

The code 1035 may include instructions to implement aspects of the present disclosure, including instructions to support dynamic accessibility compliance of a website. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

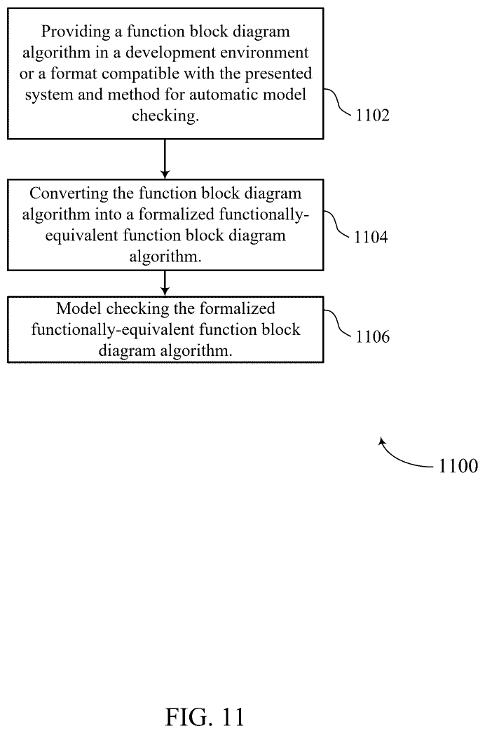

FIG. 11 illustrates a flow chart illustrating a method 1100 of model checking an algorithm. The method 1100 includes precise definitions and proven claims about function blocks, FBD algorithms, functional equivalence, functionally equivalent formalization and model checking. Some of the most fundamental underlying principles will be presented further. However, the following definitions and claims will be presented compressed and without proof and some boundary conditions for better clarity.

The method 1100 be applied to any graphical PLC programming language. FBDs are the most difficult because they can contain the largest number of function blocks with complex dynamics, and the rules for their assembly are more relaxed than in the case of SFC or LD. It is important to mention here that both SFC and LD algorithms can be machine-converted to equivalent FBD algorithms. Thus, the described methods for FBD algorithms can be used on such converted algorithms without losing generality. Any LD algorithm can be converted directly to an equivalent implementation in FBD, so the translation is relatively straightforward. In the case of SFC, an entire SFC algorithm can be replaced by a single function block that contains and describes all the dynamics implemented by the SFC algorithm. Such a function block must always be produced for each given SFC algorithm.

The method 1100 may include defining a deterministic function block. The following definition complies with the well-known definition of a deterministic discrete-time dynamic system. The discrete-time is represented by a discrete time step k∈N₀.

Definition 7—A deterministic function block in a discrete-time system can be formally defined as a sextuple F (u, y, x, x₀, f, g) such that:

$$F : x ( k + 1 ) = f ( x ( k ) , u ( k ) ) , k ∈ {N}_{0}$$

$$y ( k ) = g ( x ( k ) , u ( k ) ) ,$$

$$x ( 0 ) = {x}_{0} ,$$

where u represents inputs, y represents outputs and x represents inner states of the function block. Furthermore, u(k)∈FU, y(k)∈FY, x(k)∈FX represent values of the function block's inputs, outputs and inner states at a discrete time step k, and x₀∈FX represents an initial value of the function block's inner states. Functions f( ) and g( ) are time-invariant deterministic functions defined as:

$$f : ( FU \times FX ) \to FX ,$$

$$g : ( FU \times FX ) \to FY .$$

Additionally, the function block's inner states x can be virtually divided into two groups:

$$x = ( {x}_{M} , {x}_{A} ) ,$$

$${x}_{0} = ( {x}_{0 , M} , {x}_{0 , A} ) ,$$

where x_{M} represents modelled states and x_{A} represents auxiliary states, x_{M}(k)∈FX_{M} and x_{A}(k)∈FX_{A} represent values of the function block's modelled states and auxiliary states at a discrete time step k, and x_{0,M}∈FX_{M}, x_{0,A}∈FX_{A} represent initial values of the function block's modelled states and auxiliary states. Furthermore, lets define a set of input variables U, a set of output variables Y, a set of modelled state variables X_{M} and a set of auxiliary state variables X_{A} which represent particular variables of inputs u, outputs y, modelled states x_{M} and auxiliary states x_{A} respectively:

$$u = ( {u}_{0} , … , {u}_{n} ) , {u}_{i} ∈ U ,$$

$$y = ( {y}_{0} , … , {y}_{n} ) , {y}_{i} ∈ Y ,$$

$${x}_{M} = ( {x}_{M , 0} , … , {x}_{M , n} ) , {x}_{M , i} ∈ {X}_{M} ,$$

$${x}_{A} = ( {x}_{A , 0} , … , {x}_{A , n} ) , {x}_{A , i} ∈ {X}_{A} .$$

The presented virtual division of inner states x into modelled states x_{M} and auxiliary states X_{A} is important for the functionally equivalent conversion, which will be described and utilized further in this disclosure. This division allows to reason about the same function block in various theories or modelling languages with different modelling capabilities, as one modelling language may require additional inner states to represent the same functionality that another modelling language may directly define. Modelled states x_{M} of a function block represent its inner states, essential for adequately describing its functionality. Hence, the behavior of a function block's modelled states x_{M} has to remain the same across all implementations in all modelling languages. Auxiliary states x_{A} of a function block are inner states that are not explicitly specified. However, they need to be introduced in a specific modelling language to define some more complex functionality of the function block. Therefore, auxiliary states x_{A} of a function block are relevant only for the particular implementation in the particular modelling language.

Axiom 1—A deterministic function F defined in IEC 61131-3 standard can be defined as a deterministic function block F with no internal states x.

The following axiom further clarifies how the values of a function block's inputs can be obtained. At each discrete time step, the values of the function block's inputs are copied from particular model inputs or function blocks' outputs connected to these function block's inputs.

Axiom 2—For each function block Fᵢ, the values of its input Fᵢ.uₙ(k) at any discrete time step k∈N₀ are obtained from the values of the function block's output Fⱼ.uₗ(k) or model input M.uⱼ(k) connected to the function block's input Fᵢ.uₙ. For the purposes of this disclosure, any input of a function block has to be connected to precisely one model input or one function block output.

The method 1100 may also include defining a functional block diagram algorithm comprising deterministic function blocks. An FBD algorithm includes interconnected function blocks, inputs and outputs. Therefore, the following definition contains a set of function blocks F, inputs u and outputs y of the model and a set of oriented relations R describing their connections.

Definition 8—An FBD algorithm can be defined by quadruple M (F, u, y, R) where F is a finite set of function blocks, u represents (model) inputs, y represents (model) outputs, R is a finite set of oriented relations between function blocks, model inputs and model outputs, and u(k)∈MU, y(k)∈MY represent values of the model's inputs and outputs at a discrete time step k∈N₀. Any oriented relation Rᵢ∈R represents a connection of a model input to a model output (M.uₗ, M.yₙ), a connection of a model input to a function block's input (M.uₗ, Fₘ.uₙ), a connection of a function block's output to a model output (Fⱼ.yₗ, M.yₙ) or a connection of a function block's output to a function block's input (Fⱼ.yₗ, Fₘ.uₙ). Any function block's input or model output has to be connected to exactly one function block's output or model input. All feedback loops in an FBD algorithm have to contain exactly one special loop-break block LB. Additionally, let us define a set of model input variables M.U and a set of model output variables M.Y, which represent particular variables of model inputs M.u and model outputs M.y respectively:

$$M \cdot u = ( M \cdot {u}_{0} , … , M \cdot {u}_{n} ) , M \cdot {u}_{i} ∈ M . U ,$$

$$M \cdot y = ( M \cdot {y}_{0} , … , M \cdot {y}_{n} ) , M \cdot {y}_{i} ∈ M . Y .$$

Axiom 3—The values of an FBD algorithm's M output M.yₙ(k) at any discrete time step k E No are obtained from the values of the connected model input M.uₗ(k) or the values of the connected function block's output Fj.yₗ(k).

Any directed circle in an FBD algorithm has to be disconnected by exactly one loop-break block, causing the explicit one-step delay. This is crucial, as any feedback loop without the delay would mathematically imply a set of analytic equations instead of the required sequential algorithm. It is also essential to define the one-step delay explicitly to avoid misinterpretations of the FBD algorithm.

Axiom 4—Any feedback loop (directed circle) in an FBD algorithm M has to be disconnected by utilization of exactly one special function block LB (loop-break), causing an explicit one-step delay. This special function block LB is formally defined as:

$$LB : u = ( u 1 ) ,$$

$$y = ( y 1 ) ,$$

$${x}_{M} = ( x 1 ) ,$$

$${x}_{A} = ∅ ,$$

$$x 1 ( k + 1 ) = u 1 ( k ) , k ∈ {N}_{0}$$

$$y 1 ( k ) = x 1 ( k ) ,$$

$$x 1 ( 0 ) = x {1}_{0} ,$$

where xl₀ is a null value. Outside feedback loops, multiple loop-break blocks can be connected to cause longer than one-step delay.

The method 1100 may further include defining a modelled state, an auxiliary state, a relational state, or a complete state of the functional block diagram algorithm. The following definitions of an FBD algorithm's modelled states, auxiliary states, relations states, complete state characterization and modelled complete state characterization, will be further used for easier reasoning about FBD algorithms. For any FBD algorithm, only modelled states and auxiliary states of its function blocks can hold any internal value. Hence, these variables can be interpreted as modelled states and auxiliary states of the FBD algorithm. Furthermore, any connection of two function blocks or function blocks and model inputs and outputs can be virtually understood to hold a value for the specific discrete time step. Thus, all function blocks' inputs and outputs can be interpreted as relational states of the FBD algorithm; model inputs and outputs are excluded. The relational states of the FBD algorithm do not hold any inner value, but they can be used for reasoning about the transfer of information between connected function blocks. An FBD algorithm's complete state characterization represents all variables of the FBD algorithm. An FBD algorithm's modelled complete state characterization represents all variables of the FBD algorithm except auxiliary state variables of its function blocks.

Definition 9-Modelled states M.x_{M} of an FBD algorithm M (F, u, y, R) consist of modelled states Fᵢ.x_{M} of its name-ordered function blocks Fᵢ∈F. Auxiliary states M.x_{A} of an FBD algorithm M consist of auxiliary states Fᵢ.x_{A} of its name-ordered function blocks Fᵢ∈F. Initial values of modelled states M.x_{0,M} of an FBD algorithm M consist of initial values of modelled states Fᵢ.x_{0,M} of its name-ordered function blocks Fᵢ∈F. Initial values of auxiliary states M.x_{0,A} of an FBD algorithm M consist of initial values of auxiliary states Fᵢ.x_{0,A} of its name-ordered function blocks Fᵢ∈F. Relational states M.r of an FBD algorithm M consist of inputs Fᵢ.u and outputs Fᵢ.y of its name-ordered function blocks Fᵢ∈F. Complete state characterization M.v of an FBD algorithm M includes its modelled states M.x_{M}, auxiliary states M.x_{A}, relational states M.r, inputs M.u and outputs M.y. Modelled complete state characterization M.v_{M} of an FBD algorithm M includes its modelled states M.x_{M}, relational states M.r, inputs M.u and outputs M.y.

$$M \cdot {x}_{M} = ( {F}_{1} \cdot {x}_{M} , {F}_{2} \cdot {x}_{M} , … , {F}_{n} \cdot {x}_{M} ) , {F}_{i} ∈ F$$

$$M \cdot {x}_{M} = ( {F}_{1} \cdot {x}_{M} , {F}_{2} \cdot {x}_{M} , … , {F}_{n} \cdot {x}_{M} ) , {F}_{i} ∈ F$$

$$M \cdot {x}_{0 , M} = ( {F}_{1} \cdot {x}_{0 , M} , {F}_{2} \cdot {x}_{0 , M} , … , {F}_{n} \cdot {x}_{0 , M} ) , {F}_{i} ∈ F$$

$$M \cdot {x}_{0 , A} = ( {F}_{1} \cdot {x}_{0 , A} , {F}_{2} \cdot {x}_{0 , A} , … , {F}_{n} \cdot {x}_{0 , A} ) , {F}_{i} ∈ F$$

$$M \cdot r = ( {F}_{1} \cdot u , {F}_{1} \cdot y , {F}_{2} \cdot u , {F}_{2} \cdot y , … , {F}_{n} \cdot u , {F}_{n} \cdot y ) , {F}_{i} ∈ F$$

$$M \cdot v = ( M \cdot {x}_{M} , M \cdot {x}_{A} , M \cdot r , M \cdot u , M \cdot y )$$

$$M \cdot {v}_{M} = ( M \cdot {x}_{M} , M \cdot r , M \cdot u , M \cdot y )$$

Furthermore, M.v(k)∈MV, M.v_{M}(k)∈MV_{M}, M.x_{M} (k)∈MX_{M}, M.x_{A}(k)∈MX_{A}, M.r(k)∈MR represent values of the model's M complete state characterization M.v, modelled complete state characterization M.v_{M}, modelled states M.x_{M}, auxiliary states M.x_{A} and relational states M.r at a discrete time step k∈N₀, and M.x_{0,M}∈MX_{M}, M.x_{0,A}∈MX_{A} represent initial values of the model's M modelled states and auxiliary states. Additionally, let us define a set of all variables M.V and a set of all modelled variables M.V_{M} of an FBD algorithm M which represent particular variables of its complete state characterization M.v and modelled complete state characterization M.v_{M} respectively:

$$M \cdot v = ( M \cdot {v}_{0} , … , M \cdot {v}_{n} ) , M \cdot {v}_{i} ∈ M \cdot v ,$$

$$M \cdot {v}_{M} = ( M \cdot {v}_{M , 0} , … , M \cdot {v}_{M , n} ) , M \cdot {v}_{M , i} ∈ M \cdot {v}_{M} .$$

If an FBD algorithm contains two mutually separated largest connected sub graphs, then changing the values of variables of the first sub-graph never affects the values of variables of the second sub-graph; a function block from the first sub-graph is never the predecessor of any function block from the second one, and vice versa. Such separated largest connected sub-graphs will be further denoted as separable components. Each separable component can be examined separately without loss of correctness, except for a concurrent run of more separated components. Therefore, an FBD algorithm can be divided into multiple smaller separable components, which can then be examined separately. Such an approach may significantly reduce the complexity of each examined model and the required processing time of some performed computations (e.g. model checking, test case generation). Hence, each FBD algorithm will be further considered a single separable component. The largest connected subgraph refers to the maximal subset of vertices and edges within a given graph that forms a connected component, meaning a path exists between any two vertices in this subset. In simpler terms, it is the most extensive grouping of nodes and the edges connecting them within the original graph, where every node is reachable from every other node by following the edges. The goal is to identify the subgraph with maximum vertices while maintaining connectivity.

Definition 10—Separable components in an FBD algorithm represent all the largest connected sub-graphs of the FBD algorithm.

Lemma 1—All separable components are independent of each other. Values of all variables (i.e. variables of model inputs, model outputs and function blocks' inputs, outputs, modelled states and auxiliary states) of one separable component cannot be affected by values of all variables of another separable component.

Theorem 1—The behavior of any separable component can be examined separately without loss of correctness as long as the point of examination does not involve concurrent runs of multiple separable components.

Up to this point, all presented definitions and claims considered that a function block's inputs, outputs, modelled states and auxiliary states and all variables of an FBD algorithm are represented by generic variables. However, some of the following definitions and claims can only be made on function blocks and FBD algorithms with finite-state variables. Hence, a finite-state variable, a finite-state function block and a finite-state FBD algorithm are introduced.

Definition 11—A finite-state variable v; is a variable limited to a finite set of values vᵢ(k)∈Vᵢ at any discrete time step k∈N₀.

Definition 12-A finite-state function block F is a function block with input variables U, output variables Y, modelled state variables X_{M} and auxiliary state variables X_{A} represented by finite-state variables, i.e. the sets of values FU, FY, FX_{M}, FX_{A} in u(k)∈FU, y(k)∈FY, X_{M}(k)∈FX_{M}, x_{A}(k)∈FX_{A}, X_{0,M}∈FX_{M}, X_{0,A}∈FX_{A} from Definition 7 are finite.

Definition 13—A finite-state FBD algorithm M (F, u, y, R) is an FBD algorithm with input variables M.U and output variables M.Y represented by finite-state variables and consisting of finite-state function blocks F only, i.e. the sets of values u(k)∈MU, y(k)∈MY, M.v(k)∈MV, M.v_{M}(k)∈MV_{M}, M.x_{M}(k)∈MX_{M}, M.x_{A}(k)∈MX_{A}, M.r(k)∈MR, M.x_{0,M}∈MX_{M}, M.x_{0,A}∈MX_{A} from Definition 8 and Definition 9 are finite.

In practice, PLC systems are not required to implement each function block of an FBD algorithm separately, but they prototype their supported function blocks beforehand. After that, any function block of an FBD algorithm can be viewed simply as an instance of a prototyped function block. Function blocks can also be organized according to their principle and purpose in various libraries.

Definition 14—A library of function blocks is a set of predefined (prototyped) function blocks which can be used for creating FBD algorithms. Each function block instance from the function block library used in an FBD algorithm has the same variables and functions as the corresponding predefined function block. In practice, PLC systems usually allow predefined function blocks only.

The method 1100 includes providing 1102 a function block diagram algorithm in a development environment or a format compatible with the presented system and method for automatic model checking.

The method 1100 may further include determining a functionally-equivalent formal function block for each deterministic function block. Before an original FBD algorithm can be translated into an equivalent formal FBD algorithm, some equivalent conversion method has to be specified. Since the conversion method has to create an equivalent FBD algorithm, properly defining the equivalence of two FBD algorithms and describing their properties is crucial. Moreover, in order to enable automatic conversion of FBD algorithms, the equivalent conversion method has to be based on altering an original FBD algorithm's function blocks, inputs, outputs and relations. Intuitively, an original FBD algorithm can be converted into an equivalent FBD algorithm by replacing each function block with an equivalent or equivalent behaving function block. At the same time, its inputs, outputs and relations remain the same.

Selection of the proper criterion for the equivalence of two function blocks is essential, as overly strong definitions may be challenging to satisfy. However, for too weak definitions, it may be impossible to form proof about the equivalence of an original FBD algorithm and a corresponding FBD algorithm constructed by equivalent conversion. It is preferred to use some behavioral equivalence of two function blocks to enable the usage of various implementations of a function block (namely its functions f( ) and g( ) as long as they preserve its external behavior. An I/O equivalence requires that two I/O equivalent function blocks react with equal values of outputs y on equal values of inputs u. However, such equivalence would be hard to maintain in function blocks with internal states. Therefore, the selected behavioral equivalence should consider values of function blocks' inputs u, outputs y and internal states x. Furthermore, note that a function block's internal states x can be virtually divided into modelled states x_{M} and auxiliary states x_{A}. Modelled states x_{M} are such internal states of a function block that are necessary for understanding its behavior. Conversely, auxiliary states x_{A} are such internal states of a function block that have been introduced solely to define some complex behavior of the function block that cannot be defined directly in the selected modelling language. Therefore, values of auxiliary states x_{A} are important only to ensure the computing of correct values of outputs y and modelled states x_{M} in the particular implementation. Hence, the selected behavioral equivalence can be reduced onto values of function blocks' inputs u, outputs y and modelled states x_{M}.

The following functional equivalence is a behavioral equivalence that requires two functionally equivalent function blocks to have equal inputs u, outputs y, modelled states x_{M} and initial values of modelled states x_{0,M}. Simultaneously, two functionally equivalent function blocks must react with equal values of outputs and subsequent values of modelled states for equal values of modelled states and inputs. The functional equivalence of two function blocks preserves their necessary external behavior. Hence, a function block can be replaced by its functionally equivalent function block without affecting the interactions between values of their inputs, outputs and modelled states.

Definition 15—Two function blocks Fₐ, F_{b} are functionally-equivalent Fₐ=F_{b} exactly when their inputs u, outputs y, modelled states x_{M} and initial values of modelled states x_{0,M} are equal, and they react with equal current values of outputs y(k) and equal following values of modelled states x_{M} (k+1) for equal current values of inputs u(k) and modelled states x_{M} (k) at any discrete time step k∈N₀.

$$\begin{matrix}{F}_{a} ≡ {F}_{b} ⇐ ⇒ & 1 ) {F}_{a} \cdot u = {F}_{b} \cdot u , \\ & 2 ) {F}_{a} \cdot y = {F}_{b} \cdot y , \\ & 3 ) {F}_{a} \cdot {x}_{M} = {F}_{b} \cdot {x}_{M} , \\ & 4 ) {F}_{a} \cdot {x}_{0 , M} = {F}_{b} \cdot {x}_{0 , M} , \\ & 5 ) ∀ k ∈ {N}_{0} : ( {F}_{a} \cdot u ( k ) = {F}_{b} \cdot u ( k ) ) ∧ ( {F}_{a} \cdot {x}_{M} ( k ) = {F}_{b} \cdot {x}_{M} ( k ) ) = ⇒ ( {F}_{a} \cdot y ( k ) = {F}_{b} \cdot y ( k ) ) ∧ ( {F}_{a} \cdot {x}_{M} ( k + 1 ) = {F}_{b} \cdot {x}_{M} ( k + 1 ) )\end{matrix}$$

Lemma 2—If two functionally-equivalent function blocks Fₐ, F_{b} are in equal modelled states X_{M}(l) at any discrete time step l∈N₀ then they further react with equal outputs sequence (y(k))^{K}ₖ₌₁ and equal modelled states sequences (x_{M}(k))^{K+1}ₖ₌₁ for equal inputs sequences (u(k))^{K}ₖ₌₁ for any following discrete time step K≥1, K∈N₀.

The following functional equivalence of two FBD algorithms is based on the utilization of functionally equivalent function blocks F; equal model inputs M.u and outputs M.y and a mirrored set of oriented relations R (i.e. the interconnected oriented graph remains visually the same). Two functionally equivalent FBD algorithms have equal modelled states M.x_{M}, initial values of modelled states M.x_{0,M}, relational states M.r and modelled complete state characterizations M.v_{M}. Note that the functional equivalence does not preserve their auxiliary states x_{A} or their complete state characterizations M.v. Two functionally equivalent FBD algorithms react with equal values of relational states M.r, outputs M.y, modelled complete state characterizations M.v_{M} and next values of modelled states M.x_{M} for equal values of modelled states M.x_{M} and inputs M.u. After that, it will be shown that the functional equivalence of two FBD algorithms preserves their essential behavior.

Definition 16—Two FBD algorithms Mₐ, M_{b} are functionally-equivalent Mₐ=M_{b} exactly when their inputs M.u and outputs M.y are equal, and for each function block F_{a,i}∈Mₐ.F of FDB algorithm Mₐ exists a functionally-equivalent function block F_{b,i}∈M_{b}.F of FDB algorithm M_{b} and vice versa, and for each oriented relation R_{a,j}∈Mₐ.R of FDB algorithm Mₐ exists an equivalent oriented relation R_{b,j}∈M_{b}.R of FDB algorithm M_{b} and vice versa.

$$\begin{matrix}{M}_{a} ≡ {M}_{b} ⇐ ⇒ & 1 ) {M}_{a} \cdot u = {M}_{b} \cdot u , \\ & 2 ) {M}_{a} \cdot y = {M}_{b} \cdot y , \\ & 3 ) ∀ {F}_{a , i} ∈ {M}_{a} \cdot F , ∃ {F}_{b , i} ∈ {M}_{b} \cdot F : {F}_{a , i} ≡ {F}_{b , i} , \\ & 4 ) ∀ {F}_{b , i} ∈ {M}_{b} \cdot F , ∃ {F}_{a , i} ∈ {M}_{a} \cdot F : {F}_{a , i} ≡ {F}_{b , i} , \\ & 5 ) ∀ {R}_{a , j} ∈ {M}_{a} \cdot R , ∃ {R}_{b , j} ∈ {M}_{b} \cdot R : {R}_{a , j} = ( {F}_{a , h} \cdot {y}_{l} , {F}_{a , m} \cdot {u}_{n} ) = ⇒ {R}_{b , j} = ( {F}_{b , h} \cdot {y}_{l} , {F}_{b , m} \cdot {u}_{n} ) , {R}_{a , j} = ( {M}_{a} \cdot {u}_{l} , {F}_{a , m} \cdot {u}_{n} ) = ⇒ {R}_{b , j} = ( {M}_{b} \cdot {u}_{l} , {F}_{b , m} \cdot {u}_{n} ) , {R}_{a , j} = ( {F}_{a , h} \cdot {y}_{l} , {M}_{a} \cdot {y}_{n} ) = ⇒ {R}_{b , j} = ( {F}_{b , h} \cdot {y}_{l} , {M}_{b} \cdot {y}_{n} ) , {R}_{a , j} = ( {M}_{a} \cdot {u}_{l} , {M}_{a} \cdot {y}_{n} ) = ⇒ {R}_{b , j} = ( {M}_{b} \cdot {u}_{l} , {M}_{b} \cdot {y}_{n} ) , \\ & 6 ) ∀ {R}_{b , j} ∈ {M}_{b} \cdot R , ∃ {R}_{a , j} ∈ {M}_{a} \cdot R : {R}_{b , j} = ( {F}_{b , h} \cdot {y}_{l} , {F}_{b , m} \cdot {u}_{n} ) = ⇒ {R}_{a , j} = ( {F}_{a , h} \cdot {y}_{l} , {F}_{a , m} \cdot {u}_{n} ) , {R}_{b , j} = ( {M}_{b} \cdot {u}_{l} , {F}_{b , m} \cdot {u}_{n} ) = ⇒ {R}_{a , j} = ( {M}_{a} \cdot {u}_{l} , {F}_{a , m} \cdot {u}_{n} ) , {R}_{b , j} = ( {F}_{b , h} \cdot {y}_{l} , {M}_{b} \cdot {y}_{n} ) = ⇒ {R}_{a , j} = ( {F}_{a , h} \cdot {y}_{l} , {M}_{a} \cdot {y}_{n} ) , {R}_{b , j} = ( {M}_{b} \cdot {u}_{l} , {M}_{b} \cdot {y}_{n} ) = ⇒ {R}_{a , j} = ( {M}_{a} \cdot {u}_{l} , {M}_{a} \cdot {y}_{n} ) .\end{matrix}$$

Lemma 3—Two functionally-equivalent FBD algorithms Mₐ, M_{b} have equal modelled states Mₐ.x_{M}=M_{b}.x_{M}, initial values of modelled states Mₐ.x_{0,M}=M_{b}.x_{0,M}, relational states Mₐ.r=M_{b}.r and modelled complete state characterizations Mₐ.v_{M}=M_{b}.v_{M}.

Theorem 2—If two functionally-equivalent FBD algorithms Mₐ, M_{b} are in equal modelled states M.x_{M}(l) at any discrete time step l∈N₀ then they further react with equal outputs sequences (M.y(k))^{K}ₖ₌₁, equal modelled states sequences (M.x_{M}(k)^{K+1}ₖ₌₁, equal relational states sequences (M.r(k))^{K}ₖ₌₁ and equal modelled complete state characterizations sequences (M.v_{M}(k))^{K}ₖ₌₁ for equal inputs sequences (M.u(k))^{K}ₖ₌₁ for any following discrete time step K≥1, K∈N.

The method 1100 uses generic definition of conversion of the functional block diagram algorithm into a functionally-equivalent functional block diagram algorithm. Any FBD algorithm can be transformed into a functionally-equivalent FBD algorithm simply by replacing any of its function blocks by its functionally-equivalent function block. Therefore, any FBD algorithm can be also converted into a functionally-equivalent FBD algorithm by replacing all of its function blocks by functionally-equivalent function blocks; this process will be further called functionally-equivalent conversion.

Theorem 3—From an FBD algorithm Mₐ can be created a functionally-equivalent FBD algorithm M_{b} by replacing of any original function block F_{a,i}∈Mₐ.F with its functionally-equivalent function block F_{b,i} and changing the original relations R_{a,j}∈Mₐ.R to utilize the substituted function block F_{b,i} instead of the original function block F_{a,i}.

Corollary 1—From an FBD algorithm Mₐ can be created a functionally-equivalent FBD algorithm M_{b} by replacing of all original function blocks F_{a,i}∈Mₐ.F with their functionally-equivalent function blocks F_{b,i} and changing the original relations R_{a,j}∈Mₐ.R to utilize the substituted function blocks M_{b}.F instead of the original function blocks Mₐ.F. This process is called functionally-equivalent conversion of an FBD algorithm.

The method 1100 also includes converting 1104 the function block diagram algorithm into a formalized functionally-equivalent function block diagram algorithm. Any selected model checker can only process models specified in its particular formal modelling language. However, an original (abstract) FBD algorithm is primarily informal. Thus, the original FBD algorithm cannot be verified by model checking directly but it has to be transcribed into the selected formal modelling language, creating a formal FBD algorithm. It is critical that the formal FBD algorithm is functionally-equivalent with the original FBD algorithm, otherwise the model checking results of the formal FBD algorithm could not be assumed for the original FBD algorithm.

Definition 17—A formal model is a finite-state model inscribed in a formal modelling language which can be model checked by a chosen model checker.

Definition 18—A formal function block is a finite-state function block F_{F.} inscribed in a formal modelling language which can be model checked by a chosen model checker. For purposes of this disclosure a formal function block is expected to be a finite-state function block.

Definition 19—A formal FBD algorithm is a finite-state FBD algorithm M_{F} inscribed in a formal modelling language which can be model checked by a chosen model checker. A set of function blocks M_{F}.F of a formal FBD algorithm includes formal function blocks F_{F,i}∈M_{F}.F only. For purposes of this disclosure, a formal FBD algorithm is expected to be a finite-state FBD algorithm.

Definition 20—Functionally-equivalent formalization is a process (functionally-equivalent conversion) replacing original (abstract) function blocks F_{O,i}∈M_{O}.F in an original (abstract) FBD algorithm M_{O} by their functionally-equivalent formal function blocks F_{F,i}∈M_{F}.F producing a formal FBD algorithm M_{F}.

Theorem 4—A formal FBD algorithm M_{F} created by functionally-equivalent formalization from an original (abstract) FBD algorithm M_{O} is functionally-equivalent with the original FBD algorithm M_{O}≡M_{F}.

Definition 21-A formalized FBD algorithm M_{F} of an original (abstract) FBD algorithm M_{O} is a formal FBD algorithm created from the original FBD algorithm by functionally-equivalent formalization. The formalized FBD algorithm is functionally-equivalent with the original FBD algorithm M_{O}≡M_{F} (see Theorem 4).

For functionally-equivalent formalization of an original FBD algorithm, each function block utilized in the FBD algorithm must have specified its functionally-equivalent formal function block counterpart. Hence, any required formal function block should be prototyped and stored in a library of formal function blocks beforehand. Each formal function block has to be carefully prototyped according its specification. It is crucial that the formal function block is functionally-equivalent with its original function block counterpart. A formal function block has to contain the same inputs u, outputs y and modelled states x_{M} as its original counterpart. Additionally, the formal function block may contain some implementation-specific auxiliary states x_{A}.

Lemma 4—Any formal (binary-encoded finite-state) FBD algorithm M_{F} can be represented by a Kripke structure M_{K}= [symbol] AP, S, S₀, R, L [symbol] with the set of atomic propositions AP consisting of all variables M_{F}. V of the FBD algorithm M_{F} and the set of states S containing exactly one state for each of allowed binary-encoded finite-state values MV of the FBD algorithm's complete state characterization M_{F}.v. The labelling function L is predefined as L:S→2^{AP}. The total transition relation R and the set of initial states S₀ depend on the possible values of the algorithm's inputs, initial values of modelled states and auxiliary states, structure of the algorithm and utilized function blocks.

Definition 22—A library of formal function blocks is a set of predefined formal function blocks which can be employed in creating of formal FBD algorithms. Each used instance has the same variables and functions as the predefined function block.

Axiom 5—For purposes of this disclosure, a function block which is not predefined in the library of formal function blocks cannot be used for functionally-equivalent formalization of an original (abstract) FBD algorithm (i.e. it cannot be present in the formalized FBD algorithm).

Finally, the method 1100 further includes model checking 1106 the formalized functionally-equivalent function block diagram algorithm. The model checking results of a formalized FBD algorithm M_{F} against formal requirements limited onto its modelled variables M_{F}.V_{M} can be assumed in the corresponding original FBD algorithm M_{O}. Therefore, an original finite-state FBD algorithm can be verified by model checking by utilization of functionally-equivalent formalization for creation of a formalized FBD algorithm and model checking of the formalized FBD algorithm.

Theorem 5—Consider an original (abstract) finite-state FBD algorithm M_{O} and a formalized FBD algorithm M_{F} obtained by functionally-equivalent formalization of the original FBD algorithm M_{O}. Further consider a formal requirement ϕ represented by a temporal logic (LTL, CTL, CTL*) formula utilizing only modelled atomic proposition p∈AP_{M} represented by modelled variables M_{F}.V_{M} of the formalized FBD algorithm M_{F}. The results obtained by model checking of the formalized FBD algorithm M_{F} against the formal requirement ϕ can be assumed for the original FBD algorithm M_{O}.

$$1 ) ( ∃ {M}_{O} , ∃ {M}_{F} : {M}_{O} ≡ {M}_{F} ) ⋀$$

$$2 ) ( ∃ ∅ , ∀ ψ ∈ cl ( ϕ ) : \vert cl ( ψ ) \vert = 1 ⇔ ψ ∈ {M}_{F} \cdot {V}_{M} ) ⇒ ( {M}_{F} │ = ϕ ⇔ {M}_{O} │ = ϕ )$$

A closure cl(ϕ) denotes the set of all sub-formulas of the formula ϕ (including ϕ itself).

The systems and methods described herein may also include automatic test case generation and model-based testing. Testing of a PLC's application software is generally specific to that application because PLCs are commonly programmed by various algorithms inscribed in standardized programming languages. These algorithms are then compiled into application software and downloaded to the target PLC. Hence, the application software can be verified by model-based grey-box testing, meaning a set of test cases can be constructed with the internal knowledge of the algorithm, but the test cases have to consider the algorithm's inputs and outputs only. Properly designed test cases for grey-box testing can be utilized even in automatic testing performed by a testing platform physically connected to the tested PLC.

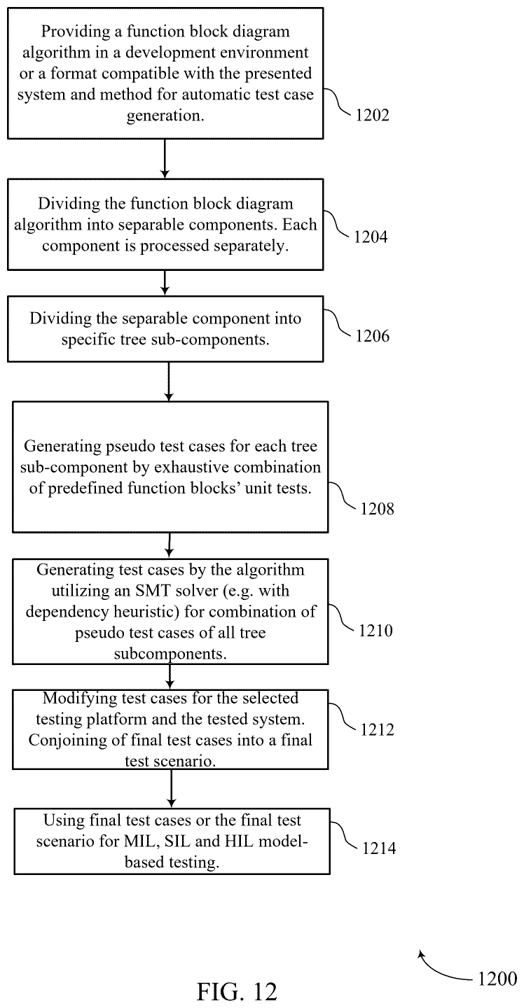

FIG. 12 illustrates a flow chart illustrating a method of test case generation and model-based testing 1200. The method 1200 includes providing 1202 a function block diagram algorithm in a development environment or a format compatible with the presented system and method for automatic test case generation. The method also includes dividing 1204 the function block diagram algorithm into separable components. Each component is processed separately. The method 1200 further includes dividing 1206 the separable component into specific tree sub-components. The method 1200 also includes generating 1208 pseudo test cases for each tree sub-component by exhaustive combination of predefined function blocks' unit tests. The method 1200 further includes generating 1210 test cases by the algorithm utilizing an SMT solver (e.g. with dependency heuristic) for combination of pseudo test cases of all tree subcomponents. The method 1200 also includes modifying 1212 test cases for the selected testing platform and the tested system. Conjoining of final test cases into a final test scenario. The method 1200 further includes using 1214 final test cases or the final test scenario for MIL, SIL and HIL model-based testing.

Methods and algorithms for the generation of test cases and model-based grey-box testing are described herein. These methods are designed to work in tandem. Initially, the test case generation method generates test cases for a discrete-time model. Thereafter, the model-based testing method utilizes these test cases to test a tested system which emulates that discrete-time model. The test case generation method is based on combining predefined testable behavior (unit tests) of function blocks using the assume-guarantee principle. The method is well suited for FBD algorithms with inner states, feedback loops, delays, and timers. The method is analytical and employs deterministic algorithms to allow repeatability of generated test cases. The quality of generated test cases can be measured by new coverage criteria. Thanks to these criteria, a test manager can be explicitly notified when some behavior of a FBD algorithm cannot be tested. Furthermore, model-based testing can be employed even for discrete-time dynamic systems simulated in real time, provided the tested PLC is implemented properly. Although the presented methods were designed for finite-state FBD algorithms, they can also be utilized on some finite-state sub-graphs of generic FBD algorithms.

Axiom 6—A tested system is expected to be some PLC or software simulation emulating the dynamics of a tested discrete-time model. A tester or a testing platform is able to supply input values to the tested system at the right discrete time step of the model and verify its output values after the execution of that step.

Definition 23—A test case for black-box testing of a discrete-time model consists of timed requirements on values of its model inputs and model outputs. Each specified value requirement represented by a triplet (v, k, c) requires a variable v at some discrete time step k to have a specific value c. An unspecified value requirement (v, k, *) utilizes the special symbol * to represent that no value is required for the variable v at the particular time step k. Thereafter, a test case TC can also be defined as a set of value requirements RV limited to values of model inputs and model outputs. The depth of a test case is the minimum number of discrete time steps required to perform it.

### Example 4

Consider a discrete-time model M with Boolean input variables Input1, Input2 and a Boolean output variable Output1. Further, consider a four discrete-time steps deep Boolean test case TC. The test case TC consists of the following value requirements.

| TC = { | | |
|---|---|---|
| (Input1, 0, 1), | (Input2, 0, 1), | |
| (Input1, 1, 1), | (Input2, 1, 0), | (Output1, 1, 0), |
| (Input1, 2, 1), | (Input2, 2, 1), | (Output1, 2, 1), |

| | |
|---|---|
| (Input1, 3, 0), | (Output1, 3, 1) |

}

This test case TC is also represented by the following table.

| k | Input1 | Input2 | Output1 |
|---|---|---|---|
| 0 | 1 | 1 | * |
| 1 | 1 | 0 | 0 |
| 2 | 1 | 1 | 1 |
| 3 | 0 | * | 1 |

Test cases are designed robustly to allow their usage at any discrete time step of a discrete-time model. Any test of a discrete-time system performed according to a robust test case can be interpreted in the relative discrete time of the test case instead of the absolute discrete time of the model. Nevertheless, in practice, a tested system may be forced to fulfil some additional requirements before a test may be started.

Lemma 5—For an FBD algorithm M without function blocks, a set of test cases can be easily generated by providing each of the possible values on the model input and verifying them at the connected model outputs.

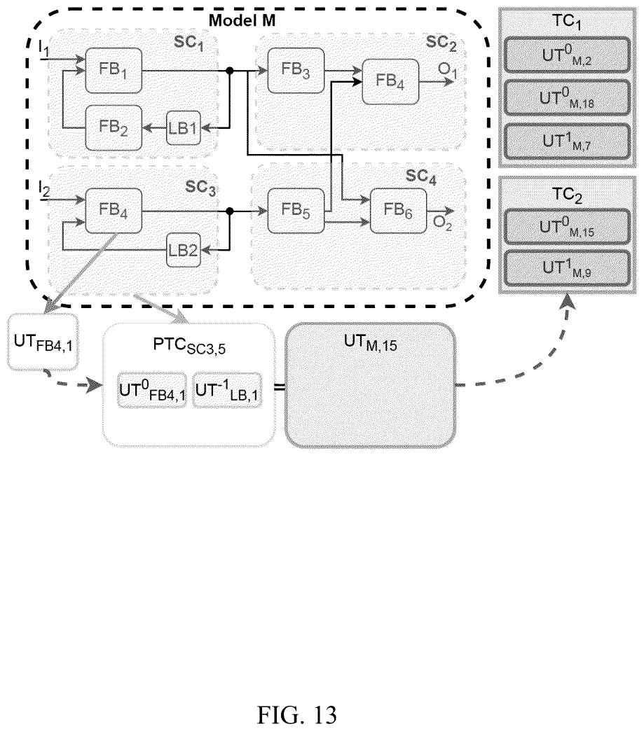

A set of test cases TCM for a finite-state binary-encoded FBD algorithm M (with at least one function block) can be generated by the combination of compatible function blocks' Fᵢ∈M.F unit tests UT_{Fi}^{τ} shifted in time τ. The presented test case generation process is illustrated in FIG. 13. The test case generation process initially divides the FBD algorithm M into specific sub-graphs (subcomponents) SC. Thereafter, it utilizes an algorithm which generates a complete set of pseudo test cases PTC_{SCj} for a subcomponent SCⱼ by combining the subcomponent's function blocks' unit tests UT_{Fi} shifted in time τ. The process then utilizes all generated pseudo test cases of all subcomponents as model unit tests UT_{M} of the FBD algorithm M. Finally, the process employs an algorithm with a custom SMT solver for the generation of test cases by the combination of model unit tests UT_{M}^{τ} shifted in time τ. The algorithm with a custom SMT solver tries to find such a set of test cases TCM that each model unit test UT_{M,i} (i.e. each testable combination of function blocks' unit tests) is utilized in at least one test case TC_{I}∈TC_{M}.

The test case generation method for FBD algorithms illustrated in FIG. 13 is based on the assume-guarantee principle. A function block is expected to react with some current values of outputs and the following values of modelled states on some current values of inputs and modelled states. A unit test represents an atomic testable behavior of a function block, which assumes some values of inputs and modelled states and guarantees particular values of outputs and modelled states. Because the behavior has to be testable, a unit test has to be both achievable and observable (either directly or indirectly). Furthermore, since input values of a function block can be obtained only by its predecessor function blocks or model inputs, the assumed values of its inputs need to be obtained either directly by model inputs or indirectly by its predecessor function blocks' unit tests that guarantee the assumed values. Conversely, a function block's outputs can be observed either directly by model outputs or indirectly by its successor function blocks' unit tests. Simultaneously, a function block can utilize one unit test to achieve such values of its modelled states that are required by another unit test in the following discrete time step. Therefore, the presented method tries to combine unit tests of function blocks of an FBD algorithm in a way that all assumed values are either directly achievable by model inputs or guaranteed by other function blocks' unit tests, and all effects are either directly observable by model outputs or required by other function blocks' unit tests. Such combinations can be translated into test cases simply by removing value requirements on other variables than model input variables and model output variables.

Definition 24—Similarly to value requirements of test cases, a specified assume-guarantee value requirement (v, k, c) requires some variable v at some discrete time step k to have some specific constant value c. However, it also carries the information whether the required value is requested c (not yet achieved), proving c⁺ (not yet observed), or resulting c (both achieved and observed). Generally, the test case generation method tries to traverse all requested value requirements to model inputs and all proving value requirements to model outputs.

Definition 25—A combination of required values r₁, r₂ of two assume-guarantee value requirements rv₁(v, k, r₁), rv₂(v, k, r₂) can be denoted as r₁Λr₂, where the combination operator is commutative and associative. The combination has to further comply with the following transcription rules: Two equal required values provide the same required value when combined r₁Λr₁=r₁. No required value is affected by combination with an unspecified value r₁Λ*=r₁. A requested requirement c₁ and a proving requirement c₁⁺ for the same constant value leads to a resulting requirement c₁ for the same constant value c₁⁻Λc₁⁺=c₁; the requested requirement has been provided by the proving requirement, and the proving requirement has been assumed by the requested requirement. A requested c₁⁻ or proving c₁⁺ requirement with a resulting requirement c₁ for the same constant value leads to a resulting requirement c₁ for the same constant value c₁⁻Λc₁=c₁, c₁⁺Λc₁=c₁; the resulting requirement is already assumed and guaranteed, so it can be used for providing of requested requirements and assuming of proving requirements. Finally, a value requirement for one constant value c₁ can never be combined with a value requirement for another constant value c₂ (i.e. these value requirements are incompatible).

Definition 26—A combination of two sets of assume-guarantee value requirements RV₁, RV₂ can be defined as a combination of their requirements for equal variables v∈M.V and discrete time steps k∈N₀, where all pairs of combined required values are compatible; incompatible sets of value requirements cannot be combined together.

Definition 27—A set of assume-guarantee value requirements RV can be shifted in time for τ∈Z discrete time steps by incrementing its value requirements' discrete time step indexes k by the constant value τ; the time-shifted set of assume-guarantee value requirements is denoted RV^{τ}.

Definition 28—A unit test is a predefined set of assume-guarantee value requirements (v, k, r). Requested c⁻ and proving c⁺ value requirements of a unit test can be resolved only by combination with other function blocks' unit tests (even shifted in time). Any requested or proving value requirement from a unit test of a function block can be resolved only by another unit test of the function block (for the function block's modelled states), by unit tests of its connected function blocks (for the function block's inputs and outputs) or by its connected model inputs and model outputs (for the function block's inputs and outputs). Moreover, any requested value requirement on model input variables and any proving value requirement on model output variables can be marked as resulting. Furthermore, any set of assume-guarantee value requirements consisting only of resulting value requirements can be transformed into a test case (in the corresponding test case grammar) by removing all value requirements on other variables than model input variables and model output variables. Unit tests must consider causality. An atomically-provable unit test is a unit test that does not add additional proving value requirements when processed.

The test case generation method requires that a set of unit tests is predefined in a library of function blocks' unit tests for each function block utilized in the verified FBD algorithm. It is crucial that unit tests of any function block are designed correctly. Ideally, a function block's unit tests should represent its complete testable behavior. Although such unit tests can be theoretically generated by some technique (e.g. generation of unit tests by model checking), in practice, they are expected to be manually specified by an expert in accordance with his experiences and knowledge about the particular function block. A unit test should be as atomic as possible because it is better to represent some complex behavior of the function block by the combination of more atomic unit tests than one big unit test.

### Example 5

Consider a function block RS representing a flip-flop with priority on reset with Boolean inputs r, s, a Boolean modelled state x1 and a Boolean output y1. All testable behavior of this function block can be divided into eight-unit tests UT_{RS,1}-UT_{RS,8} represented by the following tables.

UT_{RS, 1}

| k | r | s | x1 | y1 |
|---|---|---|---|---|
| 0 | −1 | * | * | +0 |

UT_{RS, 1}

| k | r | s | x1 | y1 |
|---|---|---|---|---|
| 0 | −1 | * | * | * |
| 1 | * | * | +0 | * |

UT_{RS, 2}

| k | r | s | x1 | y1 |
|---|---|---|---|---|
| 0 | −0 | −1 | * | +1 |

UT_{RS, 2}

| k | r | s | x1 | y1 |
|---|---|---|---|---|
| 0 | −0 | −1 | * | * |
| 1 | * | * | +1 | * |

UT_{RS, 3}

| k | r | s | x1 | y1 |
|---|---|---|---|---|
| 0 | −0 | −0 | −1 | +1 |

UT_{RS, 3}

| k | r | s | x1 | y1 |
|---|---|---|---|---|
| 0 | −0 | −0 | −1 | * |
| 1 | * | * | +1 | * |

UT_{RS, 4}

| k | r | s | x1 | y1 |
|---|---|---|---|---|
| 0 | −0 | −0 | −0 | +0 |

UT_{RS, 4}

| k | r | s | x1 | y1 |
|---|---|---|---|---|
| 0 | −0 | −0 | −0 | * |
| 1 | * | * | +0 | * |

All eight-unit tests represent some testable behavior of the function block RS. The first two-unit tests represent the function block's reaction on the resetting signal r=1 (needs to be provided), which resets the output y1=0 (needs to be proved), and the next modelled state x1=0 (needs to be proved). The second two-unit tests represent the function block's reaction on the setting signal s=1 when the reset is off r=0 (need to be provided), which sets the output y1=1 (needs to be proved) and the next modelled state x1=1 (needs to be proved). The remaining four unit tests represent the function block's reaction on both resetting and setting signals off r=0, s=0 (need to be provided) where the function block uses the current value of its modelled state x1 (needs to be provided) as the current value of the output y1 (needs to be proved) and the next value of the modelled state x1 (needs to be proved).

Theorem 6—Any set of assume-guarantee value requirements RV (e.g. a unit test, a model unit test, a test case) constructed for an FBD algorithm M_{O} by the combination of its function blocks' unit tests can be transcribed into an LTL formal requirement ϕ_{RV} representing a test performed according to the set of value requirements RV. Thereafter, a formalized FBD algorithm M_{F} can be verified by model checking against the formal requirement ϕ_{RV} to ensure the set of value requirements RV is valid and can be performed in the formalized FBD algorithm M_{F}. This process can also be interpreted as Model-In-the-Loop (MIL) testing of an FBD algorithm according to the set of value requirements RV. If the formalized model M_{F} does not satisfy the formal requirement ϕ_{RV}, then the set of value requirements cannot be utilized for testing of the FBD algorithm M_{O}. Moreover, any method or process producing such invalid sets of value requirements should be inspected and revised (repaired). Newly designed unit tests of a function block should always be verified by the presented process against its formal definition to ensure their correctness. Any generated test case can also be additionally verified by the presented process to ensure its correctness.

The test case generation method for FBD algorithms illustrated in FIG. 13 is suitable even for processing FBD algorithms with inner states, timers, split signals and feedback loops. This method has two phases. In the first phase, the method divides an FBD algorithm into multiple connected sub-graphs (tree subcomponents). Thereafter, it utilizes an algorithm providing all possible combinations of a subcomponent's function blocks' unit tests for the generation of pseudo test cases for each subcomponent. This algorithm is feasible thanks to the specific properties of subcomponents. In the second phase, the method uses all pseudo test cases of all subcomponents as unit tests of the model and provides them to a semi-analytical algorithm utilizing an SMT-solver with a dependency heuristic. This algorithm tries to create test cases by combining model unit tests. The generated set of test cases should utilize each model unit test in at least one test case. Since the first algorithm generates all possible combinations of function blocks' unit tests, and the second algorithm tries to utilize each such combination in final test cases, there is only little space for ignoring a possible solution (e.g. cyclical dependency). Nonetheless, both algorithms are, in most cases, feasible. Additionally, when some unit tests cannot be utilized in a test case, the method can explicitly notify the test manager. This section introduces the first phase of the presented method; the second phase is introduced in the following section.

Definition 29—A unit test path (UT-path) represents the information about which function blocks' unit tests shifted in time have been combined together to create the examined set of assume-guarantee value requirements. Hence, it can be utilized to reason about which function blocks' unit tests will be tested by performing tests according to the examined set of assume-guarantee value requirements. A set of assume-guarantee value requirements can always be created from its UT-path simply by combining the particular function blocks' unit tests shifted in time; the inverse operation cannot be assured.

Definition 30—A tree subcomponent is a tree sub-graph of an FBD algorithm. Each subcomponent has exactly one root function block and some of its predecessor function blocks. Nevertheless, only the root function block is allowed to have modelled states, non-atomically-provable unit tests, multiple outputs or an output connected to multiple function blocks' inputs. Any finite-state FBD algorithm can be divided into subcomponents.

### Example 6

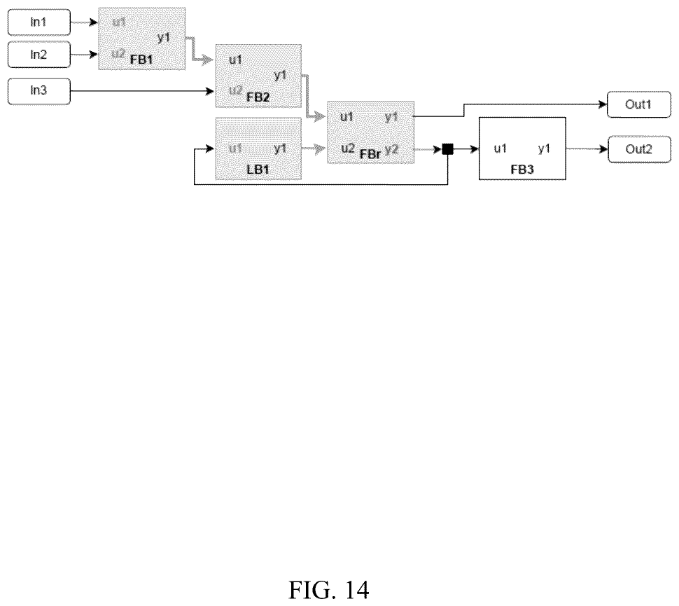

An example FBD algorithm M with a tree subcomponent SC is depicted in FIG. 14. The tree subcomponent SC is an oriented connected tree sub-graph of the FBD algorithm M. The subcomponent's function blocks SC.F includes function blocks FB1, FB2, LB1, FBr, and its relations SC.R includes their connections. The subcomponent's inputs SC.u includes FB1.u1, FB1.u2, FB2.u2, LB1.u1, and the subcomponent's outputs SC.y includes FBr.y1, FBr.y2.

Definition 31—The first phase of the test case generation method does not generate test cases for a model; it only generates pseudo test cases for each subcomponent. For a subcomponent, a pseudo test case behaves like a hybrid between a test case and a unit test. For the model, a pseudo test case behaves more like its unit test. All pseudo test cases consider the influence of model inputs and model outputs connected to the subcomponent's inputs and outputs.

The first algorithm of the test case generation method can be utilized for the generation of pseudo test cases (with their respective UT-paths) for a tree subcomponent. For each unit test of the root function block, the algorithm generates all possible combinations of unit tests of its predecessor function blocks and stores those that can be utilized as pseudo test cases. The algorithm is finite and produces pseudo test cases with exactly one unit test of the root function block. Moreover, for a subcomponent where each function block has its (atomic) testable behavior completely specified by its unit tests, the algorithm generates such set of pseudo test cases that represents the complete (atomic) testable behavior of the subcomponent.

The second algorithm of the presented test case generation method is based on combining model unit tests of an FBD algorithm. A set of model unit tests of an FBD algorithm can be obtained by dividing an FBD algorithm into tree subcomponents, generating pseudo test cases for each subcomponent by the presented first algorithm and unionizing the obtained sets of pseudo test cases of all subcomponents. Thereafter, the second algorithm utilizing an SMT solver with a dependency heuristic can be employed to combine these model unit tests into final test cases.

Definition 32—A model unit test path (MUT-path) represents the information about which model unit tests shifted in time have been combined together to create the examined set of assume-guarantee value requirements. Hence, it can be utilized to reason about which model unit tests will be tested by performing tests according to the examined set of assume-guarantee value requirements. A set of assume-guarantee value requirements can always be created from its MUT-path simply by combining the particular model unit tests shifted in time; the inverse operation cannot be assured. Furthermore, if all model unit tests have specified their UT-paths then the UT-path of the set of value requirements can be created from its MUT-path.

Finally, the second algorithm may request and prove dependencies, employ an SMT solver with a non-circular dependency heuristic, and employ two possible implementations of the SMT solver. The dependency represents which model unit tests can be combined with the model unit test causing an unresolved assume-guarantee value requirement. The second algorithm generates test cases by selecting any yet unused model unit test and passing it to a test case generating SMT solver. If the SMT solver returns a test case, then the algorithm marks all model unit tests utilized (combined together) in the test case as used. If the SMT solver does not return a solution, then the algorithm marks the model unit test as unsolvable. The quality of the generated test cases may vary due to the utilized SMT solver and further optimizations.

Due to the introduction of completely new test case generation principles, new coverage criteria was defined to allow reasoning about the quality of generated sets of test cases. These criteria can be modified to represent the coverage of function blocks' unit tests, coverage of model unit tests, count of generated pseudo test cases, count of generated test cases and their combined length. The test case generation method should ideally generate minimum test cases covering (utilizing) all function blocks' unit tests and all model unit tests. Additionally, thanks to these criteria, a test manager can be notified if a function block's unit test or a model unit test cannot be utilized.

Definition 33—Consider a binary-encoded finite-state FBD algorithm M with model unit tests UT_{M} constructed by combining compatible function blocks' Fᵢ∈M.F unit tests UT_{Fi} shifted in time. Quality of a set of test cases TCM with MUT-paths and UT-paths generated for the FBD algorithm M by combining compatible model unit tests UT_{M} shifted in time can be measured by the following criteria. Quality of the set of test cases TCM is maximized for minimal values of the criteria in the following order (from highest priority to lowest priority).
i. Count of unused model unit tests criterion UMUT.
ii. Count of unused function blocks' unit tests criterion UUT.
iii. Count of test cases criterion TCC.
iv. Sum of the depth of test cases criterion TCD.

For better clarity and easier management, test cases can be grouped into a single test scenario by placing one test case after another. Thereafter, a tester or a testing platform may use the whole test scenario to test a tested system. If a tested system or a discrete-time model needs some resetting sequence to ensure that the model is in some stabilized state, then this sequence has to be placed in the test scenario before each test case. The test cases can also be modified by various generic or platform-specific modifications during the construction of the test scenario. For example, a selected testing platform may be required to translate test cases from discrete time to real time.

Additionally, in some embodiments, the methods described herein may include systems and methods for building and verifying libraries of function blocks. PLC systems may each have a different library of function blocks (set of predefined function blocks). Even when two PLC systems support the same function block, the blocks may each behave differently. Moreover, even if two PLC systems have equivalent function blocks, they can differ in their operation software, execution of the programmed algorithm, and/or in other aspects. As such, creating a formal FBD algorithm equivalent with the original FBD algorithm or generation of test cases may require the internal knowledge about the selected PLC system, its operation system, the interpretation of algorithms, and the exact implementation of each function block that is present in the original FBD algorithm.

Libraries of function blocks suitable for model checking and test case generation are created for each PLC system separately in cooperation with its producer by obtaining and using the internal knowledge about its behavior and development and by creating and verifying each formal function block and function block's unit tests with caution. This includes verifying that each formal function block is “functionally-equivalent” to its original function block according to Definition 15. Verification includes verifying that two function blocks with the same initial values of modelled states produce the same values outputs. This is easier to prove than proving full equivalence of these function blocks. As such, in the methods described herein, the systems predetermine the functional equivalence of formal function blocks with their original counterparts. Then, the remaining definitions and proofs in the document only proves that two FBD algorithms with the same structure and functionally-equivalent function blocks are also functionally-equivalent, and any two functionally-equivalent FBD algorithms have the same model checking results (under some additional conditions). Verification of a function block's unit tests includes testing of the single function block in a target PLC according to the function block's unit tests. Verification of a function block's unit tests also includes model checking of the formal function block against an LTL requirement constructed from a unit test (i.e. MIL testing).

Accordingly, libraries and additional processes are preprogrammed into the software that includes the systems and methods described herein. That is, the systems and methods described herein include developed and verified prototypes of typical and widely used function blocks (e.g. logical AND, logical OR, delay, flip-flop). However, a user of a PLC system can program an FBD algorithm with multiple function blocks (i.e. multiple logical ANDs, ORs, delays, flip-flops, . . . ), define some formal requirements on this FBD algorithm, and/or use our software to convert the original FBD algorithm to the functionally-equivalent formal FBD algorithm and execute a 3rd party model checker to verify if the original FBD algorithm comply its formal specification. Instantly, the “proofs” provided by the model checker for the formalized FBD algorithm are valid also for the original FBD algorithm. Once the systems and methods described herein are developed, the systems and methods contain all predefined function blocks and can be used repeatedly without limitations. The systems and methods described herein make the conversion and execution of the 3rd party model checker automatically, by execution of command-line applications. However, the systems and methods described herein can also be integrated in some designing tools of the particular PLC system. Thus, after a user develops some FBD algorithm, the systems and methods described herein can determine if the FBD algorithm is correct. If not, the systems and methods described herein can generate a counterexample. The user can then read the counterexample to find out, which behavior of the FBD algorithm violates the formal specification, to repair this behavior by correcting the FBD algorithm. Then, the systems and methods described herein can verify the modified FBD algorithm. Once the model checker returns “proofs” that his FBD algorithm satisfies the formal requirements, then the systems and methods described herein can continue with compiling and downloading the FBD algorithm in the target physical PLC.

The systems and methods disclosed herein relate to, among other things, automatically converting a PLC algorithm into a functionally equivalent formal PLC algorithm and verify it by model checking in a process called functional-equivalent formalization. Because the formal PLC algorithm is proven to be functionally equivalent to the original PLC algorithm, the obtained model checking result for the formal PLC algorithm can be immediately assumed in the original PLC algorithm. Therefore, a model checking against some formal requirements can automatically verify an original PLC algorithm.

The systems and methods described herein may be extended to parse and convert PLC algorithms of various PLC systems and from multiple computer-readable notations (i.e. various designing tools). Additionally, the systems and methods may be integrated into the development tools provided by a producer of a particular PLC system. This way, a developer of PLC algorithms can verify the PLC algorithms he designed by model checking immediately after he designs them.

The systems and methods described herein mainly focus on model checking of PLC algorithms inscribed in graphical languages (i.e. FBD, SFC, LD). The methodology was initially developed for FBD algorithms. However, since FBD is the most complex language and SFC and LD can be easily transformed into FBD, the methodology can also be applied to these algorithms and their combinations.

The idea of transforming an original FBD algorithm into a formal one is shown in FIG. 5. A formal FBD algorithm is subsequently created from the original FBD algorithm by replacing the original function blocks with their functionally equivalent formal counterparts. Each utilized original function block from a library of original function blocks has to have its functionally equivalent formal function block in a library of formal function blocks. These function blocks have to be defined only once by the producer of the particular PLC system. Note that the functional equivalence of two function blocks is easier to maintain and verify than their equality. Additional limitations of function block that can be verified may arise from the limitations of the utilized model checker (e.g. a requirement on finite-state models only).

The formal requirements (LTL, CTL) are manually created from the human-readable original specification of the given system before the model checking starts. These formal requirements must be provided with the original PLC algorithm in the presented SW. Once the systems and methods described herein create the functionally equivalent formal PLC algorithm, it internally executes the selected model checker to perform model checking of the formal PLC algorithm against its formal requirements. After that, the SW processes and returns the results to the developer. Since the formal PLC algorithm is functionally equivalent to the original PLC algorithm, the model checking results (against correctly specified formal requirements) for the formal PLC algorithm can also be assumed for the original PLC algorithm. Therefore, an original PLC algorithm can be verified using the formalized PLC algorithm's functionally equivalent conversion and model checking.

Each PLC algorithm has to be designed by a PLC algorithm developer (programmer) in a development environment, and a producer of a particular PLC system provides development tools. Once the developer designs all PLC algorithms according to their specification, these algorithms should be ideally verified by model checking to detect hidden faults and misinterpretations of the specification. Additionally, these verified PLC algorithms can be used for generation of test-cases and model-based testing of the physical PLC implementing these PLC algorithms.

Currently, using model checking of PLC algorithms in practice involves several additional steps and people. There is no unified general tool for model checking the PLC algorithm yet. Thus, any new FBD algorithm has to create its formal model manually. This work requires a highly skilled expert in formal modelling and PLC systems. The expert has to analyze the designed PLC algorithms manually and the used PLC system and carefully create a correct formal model. This model may and may not be equivalent to the verified PLC algorithms. Thus, the obtained model-checking results may or may not be expected in the verified PLC algorithms. Note that in some cases, the expert may even do this simplification intentionally, but then he must correctly interpret the obtained model checking results. At the same time, an expert on formal safety requirements has to analyze the human-readable specification and manually create a formal specification consisting of particular formal requirements (e.g. LTL or CTL requirements ϕ). After that, a selected model checker automatically performs the model checking. The PLC algorithms must be repaired if the formal model does not satisfy its formal requirements. Since a standard developer of PLC algorithms is not expected to be an expert on formal modelling, its company has to hire an expert or order contract research for each verified set of PLC algorithms, which is time-consuming and financially demanding. The idea of model checking of formal models manually constructed by a formal modelling expert is shown in FIG. 6 with the parts of the development process where the verification by model checking can be applied.

The systems and methods described herein automate model checking of PLC algorithms. The systems and methods described herein can be either utilized as a standalone application or implemented directly into the development tools provided by a producer of a particular PLC system. Either way, a developer can verify its PLC algorithms by model checking immediately after he designs them. Hence, only PLC algorithms verified by model checking should be compiled and uploaded into the target PLC device. However, suppose a PLC algorithm does not satisfy its formal requirements. In that case, the developer can immediately analyze the obtained counterexample and use it to repair the PLC algorithm violating the formal requirement. Thereafter, verifying the repaired PLC algorithm by model checking should be repeated until it completely satisfies its formal specification. It is also necessary to specify formal requirements in temporal logic (LTL, CTL) before the model checking is started. Nonetheless, it is possible to train a person in basic temporal logic and let him write the simplest and recurring formal requirements according to some explicit guidebook. This may reduce the need for an expert on formal safety requirements.

The advantage of this modified process is that a developer can verify any PLC algorithm by automated model checking with a single push of a button in the development tools of the particular PLC system. There is no need to use the expertise of experts and contract researchers, which can be expensive. Hence, model checking of the PLC algorithm incorporated in this way can lead to time and money savings during the development of PLCs and to much higher safety and reliability of developed systems. This is shown in FIG. 7 on the parts of the development process where the verification by automated model checking with the systems and methods described herein can be applied.

Specifically, incorporating tools for model checking into a given SW development environment simplifies the use of model checking. This way, a PLC algorithm can be designed and verified in the same development environment with minimum effort. Additionally, the approach can be applied to any graphical programming language: FBD, SFC and LD and their combinations. Additionally, incorporating the model checking method into the V-diagram can lead to substantial cost savings caused by early detection of faults and misinterpretations in designed PLC algorithms. Additionally, incorporating the model checking method into the V-diagram leads to significantly safer, more reliable and higher quality systems and products. Moreover, the integration of the systems and methods described herein into development tools of PLC systems can lead to a broader use of model checking in industry, even in fields where it has not yet been employed due to required time and finance. Furthermore, the systems and methods described herein can be combined with methods for automatic test generation and automatic model-based testing. Once a PLC algorithm is verified by model checking, a set of test cases can be generated for MIL (Model In the Loop), SIL (Software In the Loop) and HIL (Hardware In the Loop) grey-box testing to verify that the checked PLC algorithm is correctly implemented in the target PLC. Utilizing the method for test case generation and model-based testing for verification of the PLC implementing this algorithm is illustrated in FIG. 8.

It should be noted that the methods described herein describe possible implementations, and that the operations and the steps may be rearranged or otherwise modified and that other implementations are possible. Furthermore, aspects from two or more of the methods may be combined.

If wireless communications are used, the techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 805.11 (Wi-Fi), IEEE 805.16 (WiMAX), IEEE 805.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein may include one or more carriers.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical venues. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

### Terminology and Interpretative Conventions

Any methods described in the claims or specification should not be interpreted to require the steps to be performed in a specific order unless stated otherwise. Also, the methods should be interpreted to provide support to perform the recited steps in any order unless stated otherwise.

Spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The terms have, having, include, and including should be interpreted to be synonymous with the terms comprise and comprising. The use of these terms should also be understood as disclosing and providing support for narrower alternative embodiments where these terms are replaced by “consisting” or “consisting essentially of.”

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

All disclosed numerical values are to be understood as being variable from 0-100% in either direction and thus provide support for claims that recite such values or any and all ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range (e.g., 15.2).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

The subject matter recited in the claims is not coextensive with and should not be interpreted to be coextensive with any embodiment, feature, or combination of features described or illustrated in this document. This is true even if only a single embodiment of the feature or combination of features is illustrated and described in this document.

What is claimed:

1. A method for model checking an algorithm, the method includes:
obtaining a functional block diagram algorithm of a PLC, wherein a verified PLC algorithm is a functional block diagram algorithm consisting of discrete-time deterministic function blocks with inputs, outputs and inner states which are downloaded into a target PLC and periodically executed;
converting the functional block diagram algorithm into a functionally-equivalent formalized functional block diagram algorithm; and
model checking the functionally-equivalent formalized functional block diagram algorithm.

2. The method of claim 1, wherein the deterministic function block comprises a sextuple F(u, y, x, x₀, f, g) such that:
$$F : x ( k + 1 ) = f ( x ( k ) , u ( k ) ) , k ∈ {N}_{0}$$
$$y ( k ) = g ( x ( k ) , u ( k ) ) ,$$
$$x ( 0 ) = {x}_{0} ,$$
where u represents inputs, y represents outputs and x represents inner states of the function block, wherein u(k)∈FU, y(k)∈FY, x(k)∈FX represent values of the function block's inputs, outputs and inner states at a discrete time step k, and x₀∈FX represents an initial value of the function block's inner states; and wherein functions f( ) and g( ) comprise time-invariant deterministic functions defined as:
$$f : ( FU \times FX ) \to FX , and$$
$$g : ( FU \times FX ) \to FY ;$$
the function block's inner states x are virtually divided into two groups:
$$x = ( {x}_{M} , {x}_{A} ) ,$$
$${x}_{0} = ( {x}_{0 , M} , {x}_{0 , A} ) ,$$
wherein x_{M} represents modelled states and X_{A} represents auxiliary states, x_{M}(k)∈FX_{M} and x_{A}(k)∈FX_{A} represent values of the function block's modelled states and auxiliary states at a discrete time step k, and x_{0,M}∈FX_{M}, x_{0,A}∈FX_{A} represent initial values of the function block's modelled states and auxiliary states.

3. The method of claim 1, wherein the functional block diagram algorithm is defined by a quadruple M (F, u, y, R) where F is a finite set of function blocks, u represents (model) inputs, y represents (model) outputs, R is a finite set of oriented relations between function blocks, model inputs and model outputs, and u(k)∈MU, y(k)∈MY represent values of the model's inputs and outputs at a discrete time step k∈N₀.

4. The method of claim 1, wherein the modelled state comprises modelled states Fᵢ.x_{M} of the functional block diagram algorithm's name-ordered function blocks Fᵢ∈F, wherein the auxiliary state comprises auxiliary states Fᵢ.x_{A} of its name-ordered function blocks Fᵢ∈F, wherein the relational state comprises inputs Fᵢ.u and outputs Fᵢ.y of its name-ordered function blocks Fᵢ∈F, and wherein the complete state comprises the modelled state M.x_{M}, the auxiliary state M.x_{A}, the relational states M.r, the inputs M.u, and the outputs M.y.

5. The method of claim 1, wherein a function block is functionally equivalent to the deterministic function block when inputs u, outputs y, modelled states x_{M} and initial values of modelled states x_{0,M} of both function blocks are the equal, and both function blocks react with equal current values of outputs y(k) and equal following values of modelled states x_{M}(k+1) for equal current values of inputs u(k) and modelled states x_{M} (k) at any discrete time step k∈N₀.

6. The method of claim 1, wherein converting the functional block diagram algorithm into a functionally-equivalent functional block diagram algorithm comprises replacing each function block with the corresponding functionally-equivalent function block.

7. The method of claim 1, wherein the formal function block diagram algorithm comprises a finite-state model inscribed in a formal modelling language.

8. The method of claim 1, wherein the formal function block diagram algorithm comprises formal function blocks, each comprising a finite-state function block F_{F,i} inscribed in a formal modelling language.

9. The method of claim 1, wherein the formal functional block diagram algorithm obtained by functionally-equivalent formalization (i.e. replacing of all original function blocks of an original function block diagram by their functionally-equivalent formal counterparts) is functionally-equivalent to the original functional block diagram algorithm.

10. The method of claim 1, further comprising defining a formalized functionally-equivalent functional block for each deterministic function block.

11. The method of claim 1, further comprising proving that any formal finite-state function block diagram can be represented by a Kripke structure with AP consisting of all its variables. Hence, any formal finite-state function block diagram can be verified by model checking against formal requirements constructed from atomic requirements AP consisting of all its variables.

12. The method of claim 1, wherein checking the original functional block diagram algorithm comprises checking its functionally-equivalent formalized functional block diagram algorithm against at least one formal requirement.

13. The method of claim 12, further comprising defining the at least one formal requirement on subset of atomic requirements AP consisting of its all-modelled variables.

14. The method of claim 12, wherein results for checking the formalized functionally-equivalent functional block diagram algorithm against at least one formal requirement are assumed to be valid for the original functional block diagram algorithm.

15. A method for generation of test cases for a PLC algorithm inscribed in a graphical programming language and model-based grey-box testing of the PLC implementing the PLC algorithms, the method comprises:
obtaining a functional block diagram algorithm of a PLC, wherein a verified PLC algorithm is a functional block diagram algorithm comprising discrete-time deterministic function blocks with inputs, outputs and inner states which are downloaded into a target PLC and periodically executed;
parsing the functional block diagram algorithm into separable components;
parsing separable components into tree-graph subcomponents;
exhaustive generation of subcomponents' pseudo test cases from function blocks' unit tests;
SMT based generation of test cases from subcomponents' pseudo test cases;
modifying the test cases of separable component for the selected testing architecture and joining them into test scenarios; and
using the resulting test scenarios and test cases for model-based grey-box testing in MIL, SIL and HIL testing of the PLC implementing these PLC algorithms.

16. The method of claim 15, wherein exhausting generation of subcomponents' pseudo test cases from function blocks' unit tests and SMT based generation of test cases from subcomponents' pseudo test cases comprises resolving of assume-guarantee value requirements from a model's function blocks' unit tests by traversing all requested value requirements to model inputs and all proving value requirements to model outputs.

17. The method of claim 16, wherein SMT based generation of test cases from subcomponents' pseudo test cases comprises generating, by a combination of compatible subcomponents' pseudo test cases PTC_{SCj}^{τ} shifted in time τ.

18. The method of claim 17, wherein an algorithm generates a complete set of pseudo test cases PTC_{SCj} for a subcomponent SCⱼ by combining the subcomponent's function blocks' unit tests UT_{Fi} shifted in time τ.

19. The method of claim 15, wherein a specified assume-guarantee value requirement (v, k, c) requires some variable v at some discrete time step k to have some specific constant value c.

20. The method of claim 15, wherein a combination of required values r₁, r₂ of two assume-guarantee value requirements rv₁(v, k, r₁), rv₂(v, k, r₂) can be denoted as r₁Λr₂, where the combination operator is commutative and associative, wherein the combination of the required values follows the grammar of assume-guarantee value requirements.
